(19) United States
(12) Patent Application Publication
(10) Pub. No.: US 2025/0184131 A1
(43) Pub. Date: Jun. 5, 2025

(54) KEY OBTAINING METHOD AND APPARATUS

(71) Applicant: HUAWEI TECHNOLOGIES CO., LTD., Shenzhen, Guangdong (CN)

(72) Inventors: Donghui WANG, Beijing (CN); Fei LIU, Singapore (SG)

(21) Appl. No.: 19/051,682

(22) Filed: Feb. 12, 2025

Related U.S. Application Data
(63) Continuation of application No. PCT/CN2022/113779, filed on Aug. 19, 2022.

(51) Int. Cl. H04L 9/08; H04L 9/00; H04L 9/32

(52) U.S. Cl. CPC H04L 9/0866; H04L 9/0869; H04L 9/3271; H04L 9/50

(57) ABSTRACT

A terminal may send, to a first node, a first message indicating that the terminal is to access a network, so that the first node configures a key for the terminal and the network to be accessed by the terminal. In this way, authentication or authorization can be performed between the terminal and the network by using the configured key instead of a key in a SIM card, so that the SIM card and the network are unbound. Therefore, if a user expects to switch the network, the user does not need to replace the SIM card, thereby improving user experience.

### CROSS-REFERENCE TO RELATED APPLICATIONS

This application is a continuation of International Application No. PCT/CN2022/113779, filed on Aug. 19, 2022, the disclosure of which is hereby incorporated by reference in its entirety.

### TECHNICAL FIELD

This application relates to the communication field, and in particular, to a key obtaining method and an apparatus.

### BACKGROUND

In a communication system, a terminal may access, by using a subscriber identity module (SIM) card, a network provided by an operator. Specifically, a user selects an operator and purchases a corresponding SIM card. A root key of the SIM card is preset in the SIM card. Before the SIM card is used, a vendor of the SIM card may send the root key of the SIM card to the operator through a production network or in an offline manner. In this way, both the operator and the terminal have the root key that can be used for authentication. When the terminal accesses a network, the operator can perform authentication and authorization based on the root key of the SIM card and provide a network service for the terminal after the authentication and the authorization succeed.

It can be learned from the foregoing descriptions that, the SIM card is bound to the network of the operator. If the user expects to switch the network, the user needs to replace the SIM card. This is very inconvenient and leads to poor user experience.

### SUMMARY

Embodiments of this application provide a key obtaining method and an apparatus, so that a SIM card and a network can be unbound. If a user expects to switch the network, the user does not need to replace the SIM card.

To achieve the foregoing objective, the following technical solutions are used in embodiments of this application.

According to a first aspect, a key obtaining method is provided. A communication apparatus that performs the method may be a terminal; or may be a module, for example, a chip or a chip system, used in the terminal. The following uses an example in which the method is performed by the terminal for description. The method includes: sending a first message to a first node, where the first message indicates that the terminal is to access a network; and receiving a second message from the first node, where the second message includes key information, the key information is used for determining a first key, and the first key is used for authentication between the terminal and a target network.

According to the method provided in the first aspect, the terminal may trigger the first node to configure the first key for the terminal, so that the terminal can perform authentication with the target network based on the first key. In this way, the terminal does not need to perform authentication with the target network by using a key in a SIM card, so that the SIM card and the network are unbound. If a user expects to switch the network, the user does not need to replace the SIM card, thereby improving user experience.

In an embodiment, the second message further includes an identifier of a first transaction and at least one of the following: an identifier of the target network or a public key of the target network; and the first transaction is a blockchain transaction corresponding to the first key.

Based on an embodiment, the first node may further send the identifier of the first transaction and the identifier of the target network and/or the public key of the target network to the terminal, so that the terminal performs authentication with the target network based on the first key and the information.

In an embodiment, the method further includes: sending a first request to the target network, where the first request is used for requesting to access the target network, and the first request includes the identifier of the first transaction; and receiving an authentication message from the target network, where the authentication message corresponds to the first key.

Based on an embodiment, the terminal may trigger the authentication between the terminal and the target network.

In an embodiment, the method further includes: sending an identifier of the terminal to the target network.

Based on an embodiment, the terminal may indicate, to the target network, the terminal that performs authentication with the target network.

In an embodiment, the method further includes: sending a second request to a first network, where the second request is used for requesting to access the first network, and the second request includes the identifier of the first transaction and the identifier of the target network; receiving first indication information from the first network, where the first indication information indicates the terminal to generate a second key, and the second key is used for authentication between the terminal and the first network; and generating the second key based on the first key and an identifier of the first network.

Based on an embodiment, the terminal may trigger the first network to obtain the second key for authentication with the terminal. In this way, authentication can be performed between the terminal and the second network based on the second key, and the target network does not need to participate in the authentication, so that an authentication procedure is simplified.

In an embodiment, the method further includes: receiving an identifier of a second transaction from the first network, where the second transaction is a blockchain transaction corresponding to the second key.

Based on an embodiment, the first network may send the identifier of the second transaction to the terminal, so that the terminal performs authentication with the first network with reference to the identifier of the second transaction.

In an embodiment, the method further includes: sending a third message to the first node, where the third message indicates a third network; receiving second indication information from the first node, where the second indication information indicates the terminal to generate a third key, and the third key is used for authentication between the terminal and the third network; and generating the third key based on the first key and an identifier of the third network.

Based on an embodiment, the terminal may trigger the first node to configure, for the terminal and the third network, the third key for authentication, so that authentication can be performed between the terminal and the third network based on the third key.

In an embodiment, an identifier of a third transaction from the first node is received, where the third transaction is a blockchain transaction corresponding to the third key.

Based on an embodiment, the first node may send the identifier of the third transaction to the terminal, so that the terminal performs authentication with the third network with reference to the identifier of the third transaction.

In an embodiment, the method further includes: sending a first random number to the first network.

Based on an embodiment, the terminal may send the first random number to the first network, so that the first network sends the first random number to the target network, and the target network generates, based on the first key and the first random number, the second key for authentication between the terminal and the first network.

In an embodiment, the identifier of the first transaction includes an address of the first transaction, or the identifier of the first transaction includes an address of the first transaction and a sequence number of the terminal in the first transaction.

Based on an embodiment, an identifier of a transaction corresponding to a key configured by the first node for each terminal may be unique. For example, if the first transaction includes information about a single terminal, the identifier of the first transaction includes the address of the first transaction. If the first transaction includes information about a plurality of terminals, the identifier of the first transaction includes the address of the first transaction and the sequence number of the terminal in the first transaction. In this way, the terminal can perform authentication with the network based on the identifier of the transaction corresponding to the terminal.

In an embodiment, the target network is determined based on selection of a user corresponding to the terminal; the target network is determined according to a preset policy; or the target network is determined by the first node.

Based on an embodiment, the target network can be flexibly selected.

In an embodiment, the key information includes the first key; or the key information includes the third key, and the third key is used for determining the first key.

Based on an embodiment, the first node may directly indicate, to the terminal, the first key for authentication with the target network; or the first node may indicate the third key to the terminal, so that the terminal generates, based on the third key, the first key for authentication with the target network.

In an embodiment, the method further includes: sending a second random number to the first node.

Based on an embodiment, the terminal may send the second random number to the first node, so that the first node generates the first key based on the second random number.

In an embodiment, that the third key is used for determining the first key includes: The third key is used for determining the first key together with the identifier of the target network and the second random number.

Based on an embodiment, the first key may be determined based on the third key, the identifier of the target network, and the second random number.

In an embodiment, the first message includes information about the target network.

Based on an embodiment, the terminal may indicate, to the first node, the target network that the terminal expects to access.

According to a second aspect, a key obtaining method is provided. A communication apparatus that performs the method may be a first node; or may be a module, for example, a chip or a chip system, used in the first node. The following uses an example in which the method is performed by the first node for description. The method includes: receiving a first message from a terminal, where the first message indicates that the terminal is to access a network; obtaining a first key, where the first key is used for authentication between the terminal and a target network; sending a third message to a blockchain node, where the third message indicates the first key to the target network; and sending a second message to the terminal, where the second message includes key information, and the key information is determined based on the first key.

Based on the method provided in the second aspect, based on triggering of the terminal, the first node may obtain the first key, and indicate the first key to the terminal and the target network. In this way, the terminal and the target network can perform authentication based on the first key, and the authentication does not need to be performed by using a key in a SIM card, so that the SIM card and the network are unbound. If a user expects to switch the network, the user does not need to replace the SIM card, thereby improving user experience.

In an embodiment, before the sending a second message to the terminal, the method further includes: obtaining an identifier of a first transaction, where the first transaction is a blockchain transaction corresponding to the first key.

Based on an embodiment, the first node may further obtain the identifier of the first transaction, so that the first node sends the identifier of the first transaction to the terminal, and the terminal performs authentication with the target network based on the identifier of the first transaction and the first key.

In an embodiment, the second message further includes the identifier of the first transaction and at least one of the following: an identifier of the target network or a public key of the target network.

Based on an embodiment, the first node may further send the identifier of the first transaction and the identifier of the target network and/or the public key of the target network to the terminal, so that the terminal performs authentication with the target network based on the first key and the information.

In an embodiment, the identifier of the first transaction includes an address of the first transaction, or the identifier of the first transaction includes an address of the first transaction and a sequence number of the terminal in the first transaction.

Based on an embodiment, an identifier of a transaction corresponding to a key configured by the first node for each terminal may be unique. For example, if the first transaction includes information about a single terminal, the identifier of the first transaction includes the address of the first transaction. If the first transaction includes information about a plurality of terminals, the identifier of the first transaction includes the address of the first transaction and the sequence number of the terminal in the first transaction. In this way, the terminal can perform authentication with the network based on the identifier of the transaction corresponding to the terminal.

In an embodiment, the method further includes: receiving a fourth message from the terminal, where the fourth message indicates a second network; sending a fifth message to the blockchain node, where the fifth message includes a fourth key, and the fourth key is used for authentication between the terminal and the second network; and sending second indication information to the terminal, where the second indication information indicates the terminal to generate the fourth key.

Based on an embodiment, based on triggering of the terminal, the first node may generate, for the terminal and the second network, the fourth key for authentication, so that the terminal and the second network can perform authentication based on the fourth key.

In an embodiment, the method further includes: obtaining an address of a third transaction, where the third transaction is a blockchain transaction corresponding to the fourth key.

Based on an embodiment, the first node may obtain the address of the third transaction corresponding to the fourth key.

In an embodiment, the method further includes: sending an identifier of the third transaction to the terminal.

Based on an embodiment, the first node may send the identifier of the third transaction to the terminal, so that the terminal and the second network perform authentication based on the fourth key and the identifier of the third transaction.

In an embodiment, the key information includes the first key; or the key information includes the third key, and the third key is used for determining the first key.

Based on an embodiment, the first node may directly indicate, to the terminal, the first key for authentication with the target network; or the first node may indicate the third key to the terminal, so that the terminal generates, based on the third key, the first key for authentication with the target network.

In an embodiment, the method further includes: receiving a second random number from the terminal.

Based on an embodiment, the first node may generate the first key based on the second random number.

In an embodiment, that the third key is used for determining the first key includes: The third key is used for determining the first key together with the identifier of the target network and the second random number.

Based on an embodiment, the first key may be determined based on the third key, the identifier of the target network, and the second random number.

In an embodiment, the blockchain node is included in the target network, and the third message is obtained by encrypting the first key by using the public key of the target network.

Based on an embodiment, the blockchain node may decrypt the third message based on the private key of the target network, to determine that the third message is related to the blockchain node.

In an embodiment, the first message includes information about the target network.

Based on an embodiment, the terminal may indicate, to the first node, the target network that the terminal expects to access.

According to a third aspect, a key obtaining method is provided. A communication apparatus that performs the method may be a node in a target network, or may be a module, for example, a chip or a chip system, used in the node in the target network. The following uses an example in which the method is performed by the node in the target network for description. The method includes: obtaining a third message; obtaining a first key based on the third message, where the first key is used for authentication between a first terminal and the target network; obtaining an identifier of a first transaction, where the first transaction is a blockchain transaction corresponding to the first key; verifying the first terminal based on the first key and the identifier of the first transaction; and sending a verification response message to the first terminal based on a verification result.

Based on the method provided in the third aspect, the node in the target network may obtain the first key and the identifier of the first transaction, and verify the first terminal based on the first key and the identifier of the first transaction. In this way, authentication between the node in the target network and the first terminal does not need to be performed by using a key in a SIM card of the first terminal, so that the SIM card and the network are unbound. If a user expects to switch the network, the user does not need to replace the SIM card, thereby improving user experience.

In an embodiment, the verifying the first terminal based on the first key and the identifier of the first transaction includes: receiving a first request from the first terminal, where the first request is used for requesting to access the target network, and the first request includes the identifier of the first transaction; and sending an authentication message to the first terminal, where the authentication message is obtained based on the first key, and the first key is obtained through query based on the first request.

Based on an embodiment, the node in the target network and the first terminal may perform authentication based on the first key and the identifier of the first transaction.

In an embodiment, before the sending an authentication message to the first terminal, the method further includes: sending a query message to a blockchain node, where the query message is used for querying for a key corresponding to the first transaction, and the query message includes the identifier of the first transaction; and receiving a response message from the blockchain node, where the response message includes the first key.

Based on an embodiment, the node in the target network may further query a blockchain for the first key, so that the verification result for the first terminal is more accurate.

In an embodiment, the method further includes: receiving an identifier of the first terminal from the first terminal.

Based on an embodiment, the node in the target network may determine, based on the identifier of the first terminal, to perform authentication on the first terminal.

In an embodiment, the method further includes: receiving a third request from a second terminal, where the third request is used for requesting to access the target network, the third request includes an identifier of a fourth transaction and an identifier of a third network, the fourth transaction is a blockchain transaction corresponding to a fifth key, and the fifth key is used for authentication between the second terminal and the third network; sending the identifier of the fourth transaction to the third network; obtaining a sixth key, where the sixth key is used for authentication between the second terminal and the target network; and sending third indication information to the second terminal, where the third indication information indicates the second terminal to generate the sixth key.

Based on an embodiment, the node in the target network may request, based on the request of the second terminal, the third network to configure, for the target network and the second terminal, the key for authentication between the target network and the second terminal, so that the target network and the second terminal can perform authentication based on the key. In this way, the third network may not need to participate in an authentication process between the second terminal and the target network, so that the authentication process is simplified.

In an embodiment, the method further includes: obtaining an identifier of a fifth transaction, where the fifth transaction is a blockchain transaction corresponding to the sixth key; and sending the identifier of the fifth transaction to the second terminal.

Based on an embodiment, the node in the target network may send the identifier of the fifth transaction to the second terminal, so that the second terminal and the target network may perform authentication based on the identifier of the fifth transaction and the sixth key.

In an embodiment, the method further includes: receiving the identifier of the first transaction from a second network; and sending a second key to the blockchain node, where the second key is used for authentication between the first terminal and the second network, the second key is obtained based on the first key, and the first key is obtained through query based on the identifier of the first transaction.

Based on an embodiment, the node in the target network may configure, for the second network and the first terminal, the second key for authentication, so that the second network and the first terminal perform authentication based on the second key. In this way, the target network may not need to participate in an authentication process between the second network and the first terminal, so that the authentication process is simplified.

In an embodiment, the identifier of the first transaction includes an address of the first transaction, or the identifier of the first transaction includes an address of the first transaction and a sequence number of the first terminal in the first transaction.

Based on the foregoing possible implementation, an identifier of a transaction corresponding to a key configured by the first node for each terminal may be unique. For example, if the first transaction includes information about a single terminal, the identifier of the first transaction includes the address of the first transaction. If the first transaction includes information about a plurality of terminals, the identifier of the first transaction includes the address of the first transaction and the sequence number of the terminal in the first transaction. In this way, the terminal can perform authentication with the network based on the identifier of the transaction corresponding to the terminal.

According to a fourth aspect, an authentication method is provided. A communication apparatus that performs the method may be a terminal; or may be a module, for example, a chip or a chip system, used in the terminal. The following uses an example in which the method is performed by the terminal for description. The method includes: obtaining an identifier of a first transaction and a first key, where the first transaction is a blockchain transaction corresponding to the first key; performing authentication with a target network based on the identifier of the first transaction and the first key; and receiving a verification response message from the target network.

Based on the method provided in the fourth aspect, the terminal may obtain the identifier of the first transaction and the first key, and perform authentication with the target network based on the identifier of the first transaction and the first key. In this way, the target network does not need to allocate a subscription permanent identifier (SUPI) to each terminal, and the target network does not need to manage a large quantity of SUPIs. This simplifies an authentication process, and saves storage resources of the target network.

In an embodiment, the performing authentication with a target network based on the identifier of the first transaction and the first key includes: sending a first request to the target network, where the first request is used for requesting to access the target network, and the first request includes the identifier of the first transaction; receiving an authentication message from the target network, where the authentication message is obtained based on the first key, and the first key is obtained through query based on the first request; and verifying the authentication message.

Based on the foregoing possible implementation, the terminal may send the identifier of the first transaction to the target network, so that the target network obtains the first key through query based on the identifier of the first transaction, obtains the authentication message based on the first key, and sends the authentication message to the terminal, to complete the authentication between the terminal and the target network.

In an embodiment, the method further includes: sending an identifier of the terminal to the target network.

Based on the foregoing possible implementation, the terminal that is to access the network can be indicated to the target network.

In an embodiment, the first request is obtained by encrypting the identifier of the first transaction by using a public key of the target network.

Based on the foregoing possible implementation, the terminal may encrypt the identifier of the first transaction and send the encrypted identifier to the target network, to improve communication security.

According to a fifth aspect, a communication apparatus is provided to implement the method according to the first aspect. The communication apparatus may be the terminal in the first aspect, or an apparatus including the terminal. The communication apparatus includes a corresponding module, unit, or means for implementing the foregoing method. The module, unit, or means may be implemented by hardware, software, or hardware executing corresponding software. The hardware or the software includes one or more modules or units corresponding to the foregoing functions.

In an embodiment, the communication apparatus may include a transceiver module. The transceiver module may also be referred to as a transceiver unit, and is configured to implement a sending function and/or a receiving function in any one of the first aspect or the possible implementations of the first aspect. The transceiver module may include a transceiver circuit, a transceiver machine, a transceiver, or a communication interface.

In an embodiment, the transceiver module includes a sending module and a receiving module, respectively configured to implement the sending function and the receiving function in any one of the first aspect or the possible implementations of the first aspect.

In an embodiment, the communication apparatus may further include a processing module. The processing module may be configured to implement a processing function in any one of the first aspect and the possible implementations of the first aspect. The processing module may be, for example, a processor.

In an embodiment, the transceiver module is configured to send a first message to a first node, where the first message indicates that the communication apparatus is to access a network; and the transceiver module is further configured to receive a second message from the first node, where the second message includes key information, the key information is used for determining a first key, and the first key is used for authentication between the communication apparatus and a target network.

In an embodiment, the second message further includes an identifier of a first transaction and at least one of the following: an identifier of the target network or a public key of the target network; and the first transaction is a blockchain transaction corresponding to the first key.

In an embodiment, the transceiver module is further configured to send a first request to the target network, where the first request is used for requesting to access the target network, and the first request includes the identifier of the first transaction; and the transceiver module is further configured to receive an authentication message from the target network, where the authentication message corresponds to the first key.

In an embodiment, the transceiver module is further configured to send an identifier of the communication apparatus to the target network.

In an embodiment, the transceiver module is further configured to send a second request to a first network, where the second request is used for requesting to access the first network, and the second request includes the identifier of the first transaction and the identifier of the target network; the transceiver module is further configured to receive first indication information from the first network, where the first indication information indicates the communication apparatus to generate a second key, and the second key is used for authentication between the communication apparatus and the first network; and the processing module is configured to generate the second key based on the first key and an identifier of the first network.

In an embodiment, the transceiver module is further configured to receive an identifier of a second transaction from the first network, where the second transaction is a blockchain transaction corresponding to the second key.

In an embodiment, the transceiver module is further configured to send a third message to the first node, where the third message indicates a third network; the transceiver module is further configured to receive second indication information from the first node, where the second indication information indicates the communication apparatus to generate a third key, and the third key is used for authentication between the communication apparatus and the third network; and the processing module is configured to generate the third key based on the first key and an identifier of the third network.

In an embodiment, the transceiver module is further configured to receive an identifier of a third transaction from the first node, where the third transaction is a blockchain transaction corresponding to the third key.

In an embodiment, the transceiver module is further configured to send a first random number to the first network.

In an embodiment, the identifier of the first transaction includes an address of the first transaction, or the identifier of the first transaction includes an address of the first transaction and a sequence number of the communication apparatus in the first transaction.

In an embodiment, the target network is determined based on selection of a user corresponding to the communication apparatus; the target network is determined according to a preset policy; or the target network is determined by the first node.

In an embodiment, the key information includes the first key; or the key information includes the third key, and the third key is used for determining the first key.

In an embodiment, the transceiver module is further configured to send a second random number to the first node.

In an embodiment, that the third key is used for determining the first key includes: The third key is used for determining the first key together with the identifier of the target network and the second random number.

In an embodiment, the first message includes information about the target network.

According to a sixth aspect, a communication apparatus is provided to implement the method according to the second aspect. The communication apparatus may be the first node in the second aspect, or an apparatus including the first node. The communication apparatus includes a corresponding module, unit, or means for implementing the foregoing method. The module, unit, or means may be implemented by hardware, software, or hardware executing corresponding software. The hardware or the software includes one or more modules or units corresponding to the foregoing functions.

In an embodiment, the communication apparatus may include a transceiver module and a processing module. The transceiver module may also be referred to as a transceiver unit, and is configured to implement a sending function and/or a receiving function in any one of the second aspect or the possible implementations of the second aspect. The transceiver module may include a transceiver circuit, a transceiver machine, a transceiver, or a communication interface. The processing module may be configured to implement a processing function in any one of the second aspect or the possible implementations of the second aspect. The processing module may be, for example, a processor.

In an embodiment, the transceiver module includes a sending module and a receiving module, respectively configured to implement the sending function and the receiving function in any one of the second aspect or the possible implementations of the second aspect.

In an embodiment, the transceiver module is configured to receive a first message from a terminal, where the first message indicates that the terminal is to access a network; the processing module is configured to obtain a first key, where the first key is used for authentication between the terminal and a target network; the transceiver module is further configured to send a third message to a blockchain node, where the third message indicates the first key to the target network; and the transceiver module is further configured to send a second message to the terminal, where the second message includes key information, and the key information is determined based on the first key.

In an embodiment, the processing module is further configured to obtain an identifier of a first transaction, where the first transaction is a blockchain transaction corresponding to the first key.

In an embodiment, the second message further includes the identifier of the first transaction and at least one of the following: an identifier of the target network or a public key of the target network.

In an embodiment, the identifier of the first transaction includes an address of the first transaction, or the identifier of the first transaction includes an address of the first transaction and a sequence number of the terminal in the first transaction.

In an embodiment, the transceiver module is further configured to receive a fourth message from the terminal, where the fourth message indicates a second network; the transceiver module is further configured to send a fifth message to the blockchain node, where the fifth message includes a fourth key, and the fourth key is used for authentication between the terminal and the second network; and the transceiver module is further configured to send second indication information to the terminal, where the second indication information indicates the terminal to generate the fourth key.

In an embodiment, the processing module is further configured to obtain an address of a third transaction, where the third transaction is a blockchain transaction corresponding to the fourth key.

In an embodiment, the transceiver module is further configured to send an identifier of the third transaction to the terminal.

In an embodiment, the key information includes the first key; or the key information includes the third key, and the third key is used for determining the first key.

In an embodiment, the transceiver module is further configured to receive a second random number from the terminal.

In an embodiment, that the third key is used for determining the first key includes: The third key is used for determining the first key together with the identifier of the target network and the second random number.

In an embodiment, the blockchain node is included in the target network, and the third message is obtained by encrypting the first key by using the public key of the target network.

In an embodiment, the first message includes information about the target network.

According to a seventh aspect, a communication apparatus is provided to implement the method according to the third aspect. The communication apparatus may be the node in the target network in the third aspect, or an apparatus including the node in the target network. The communication apparatus includes a corresponding module, unit, or means for implementing the foregoing method. The module, unit, or means may be implemented by hardware, software, or hardware executing corresponding software. The hardware or the software includes one or more modules or units corresponding to the foregoing functions.

In an embodiment, the communication apparatus may include a processing module and a sending module. The processing module may be configured to implement a processing function in any one of the third aspect and the possible implementations of the third aspect. The processing module may be, for example, a processor. The transceiver module may also be referred to as a transceiver unit, and is configured to implement a sending function and/or a receiving function in any one of the third aspect or the possible implementations of the third aspect. The transceiver module may include a transceiver circuit, a transceiver machine, a transceiver, or a communication interface.

In an embodiment, the transceiver module includes a sending module and a receiving module, respectively configured to implement the sending function and the receiving function in any one of the third aspect or the possible implementations of the third aspect.

In an embodiment, the processing module is configured to obtain a third message; the processing module is further configured to obtain a first key based on the third message, where the first key is used for authentication between a first terminal and the target network; the processing module is further configured to obtain an identifier of a first transaction, where the first transaction is a blockchain transaction corresponding to the first key; the processing module is further configured to verify the first terminal based on the first key and the identifier of the first transaction; and the transceiver module is configured to send a verification response message to the first terminal based on a verification result.

In an embodiment, the processing module is configured to receive a first request from the first terminal through the transceiver module, where the first request is used for requesting to access the target network, and the first request includes the identifier of the first transaction; and the processing module is further configured to send an authentication message to the first terminal through the transceiver module, where the authentication message is obtained based on the first key, and the first key is obtained through query based on the first request.

In an embodiment, the transceiver module is further configured to send a query message to a blockchain node, where the query message is used for querying for a key corresponding to the first transaction, and the query message includes the identifier of the first transaction; and the transceiver module is further configured to receive a response message from the blockchain node, where the response message includes the first key.

In an embodiment, the transceiver module is further configured to receive an identifier of the first terminal from the first terminal.

In an embodiment, the transceiver module is further configured to receive a third request from a second terminal, where the third request is used for requesting to access the target network, the third request includes an identifier of a fourth transaction and an identifier of a third network, the fourth transaction is a blockchain transaction corresponding to a fifth key, and the fifth key is used for authentication between the second terminal and the third network; the transceiver module is further configured to send the identifier of the fourth transaction to the third network; the processing module is further configured to obtain a sixth key, where the sixth key is used for authentication between the second terminal and the target network; and the transceiver module is further configured to send third indication information to the second terminal, where the third indication information indicates the second terminal to generate the sixth key.

In an embodiment, the processing module is further configured to obtain an identifier of a fifth transaction, where the fifth transaction is a blockchain transaction corresponding to the sixth key; and the transceiver module is further configured to send the identifier of the fifth transaction to the second terminal.

In an embodiment, the transceiver module is further configured to receive the identifier of the first transaction from a second network; and the transceiver module is further configured to send a second key to the blockchain node, where the second key is used for authentication between the first terminal and the second network, the second key is obtained based on the first key, and the first key is obtained through query based on the identifier of the first transaction.

In an embodiment, the identifier of the first transaction includes an address of the first transaction, or the identifier of the first transaction includes an address of the first transaction and a sequence number of the first terminal in the first transaction.

According to an eighth aspect, a communication apparatus is provided to implement the method according to the fourth aspect. The communication apparatus may be the terminal in the fourth aspect, or an apparatus including the terminal. The communication apparatus includes a corresponding module, unit, or means for implementing the foregoing method. The module, unit, or means may be implemented by hardware, software, or hardware executing corresponding software. The hardware or the software includes one or more modules or units corresponding to the foregoing functions.

In an embodiment, the communication apparatus may include a processing module and a transceiver module. The processing module may be configured to implement a processing function in any one of the fourth aspect and the possible implementations of the fourth aspect. The processing module may be, for example, a processor. The transceiver module may also be referred to as a transceiver unit, and is configured to implement a sending function and/or a receiving function in any one of the fourth aspect or the possible implementations of the fourth aspect. The transceiver module may include a transceiver circuit, a transceiver machine, a transceiver, or a communication interface.

In an embodiment, the transceiver module includes a sending module and a receiving module, respectively configured to implement the sending function and the receiving function in any one of the fourth aspect or the possible implementations of the fourth aspect.

In an embodiment, the processing module is configured to obtain an identifier of a first transaction and a first key, where the first transaction is a blockchain transaction corresponding to the first key; the processing module is further configured to perform authentication with a target network based on the identifier of the first transaction and the first key; and the transceiver module is configured to receive a verification response message from the target network.

In an embodiment, the processing module is configured to send a first request to the target network through the transceiver module, where the first request is used for requesting to access the target network, and the first request includes the identifier of the first transaction; the processing module is further configured to receive an authentication message from the target network through the transceiver module, where the authentication message is obtained based on the first key, and the first key is obtained through query based on the first request; and the processing module is further configured to verify the authentication message.

In an embodiment, the transceiver module is further configured to send an identifier of the communication apparatus to the target network.

In an embodiment, the first request is obtained by encrypting the identifier of the first transaction by using a public key of the target network.

According to a ninth aspect, a communication apparatus is provided. The communication apparatus includes a processor. The processor is configured to: be coupled to a memory, and after reading instructions in the memory, perform, according to the instructions, the method according to any one of the foregoing aspects. The communication apparatus may be the terminal in the first aspect, or an apparatus including the terminal; or the communication apparatus may be the first node in the second aspect, or an apparatus including the first node; or the communication apparatus may be the node in the target network in the third aspect, or an apparatus including the node in the target network; or the communication apparatus may be the terminal in the fourth aspect, or an apparatus including the terminal.

In an embodiment, the communication apparatus further includes a memory. The memory is configured to store necessary program instructions and data.

In an embodiment, the communication apparatus is a chip or a chip system. In an embodiment, when the communication apparatus is the chip system, the communication apparatus may include a chip, or may include a chip and another discrete component.

According to a tenth aspect, a communication apparatus is provided, including a processor and an interface circuit. The interface circuit is configured to: receive a computer program or instructions, and transmit the computer program or the instructions to a processor. The processor is configured to execute the computer program or the instructions, to enable the communication apparatus to perform the method according to any one of the foregoing aspects.

In an embodiment, the communication apparatus is a chip or a chip system. In an embodiment, when the communication apparatus is the chip system, the communication apparatus may include a chip, or may include a chip and another discrete component.

According to an eleventh aspect, a computer-readable storage medium is provided. The computer-readable storage medium stores instructions. When the instructions are run on a computer, the computer is enabled to perform the method according to any one of the foregoing aspects.

According to a twelfth aspect, a computer program product including instructions is provided. When the computer program product is run on a computer, the computer is enabled to perform the method according to any one of the foregoing aspects.

For technical effects brought by any one of the possible implementations in the fifth aspect to the twelfth aspect, refer to technical effects brought by any one of the first aspect to the fourth aspect or different possible implementations in any one of the aspects. Details are not described herein again.

According to a thirteenth aspect, a communication system is provided. The communication system includes a terminal configured to perform the method according to the first aspect, a first node configured to perform the method according to the second aspect, and a node in a target network configured to perform the method according to the third aspect.

It may be understood that the solutions in the foregoing aspects may be combined on a premise that the solutions are not contradictory.

### BRIEF DESCRIPTION OF DRAWINGS

FIG. 1A is a diagram 1 of an architecture of a communication system according to an embodiment of this application;

FIG. 1B is a diagram 1 of an architecture of a network according to an embodiment of this application;

FIG. 1C is a diagram 2 of an architecture of a network according to an embodiment of this application;

FIG. 1D is a diagram 2 of an architecture of a communication system according to an embodiment of this application;

FIG. 2 is a diagram of a hardware structure of a communication apparatus according to an embodiment of this application;

FIG. 3 is a schematic flowchart 1 of a key obtaining method according to an embodiment of this application;

FIG. 4 is a schematic flowchart of an authentication method according to an embodiment of this application;

FIG. 5 is a schematic flowchart 2 of a key obtaining method according to an embodiment of this application;

FIG. 6 is a schematic flowchart of a key update method according to an embodiment of this application;

FIG. 7 is a diagram 1 of a structure of a communication apparatus according to an embodiment of this application; and

FIG. 8 is a diagram 2 of a structure of a communication apparatus according to an embodiment of this application.

### DESCRIPTION OF EMBODIMENTS

Before embodiments of this application are described, related technical terms in embodiments of this application are explained and described. It may be understood that, the explanations and descriptions are intended to facilitate understanding of embodiments of this application, but should not be construed as a limitation on the protection scope claimed in embodiments of this application.

### 1. Blockchain (BC)

In embodiments of this application, a blockchain is an anti-tampering technology ensured by using a cryptography mechanism. Generally, a blockchain node may run on a physical node, or may run in a virtual environment in the physical node. This is not limited.

In an embodiment, the blockchain is a ledger technology. A ledger is a distributed ledger, and may be maintained by a plurality of nodes. When maintaining the ledger, the plurality of nodes may use the cryptography mechanism to prevent the ledger from being tampered with.

For example, the blockchain is a chained data structure obtained by combining data blocks in a chronological order, and is a distributed ledger that is cryptographically ensured to be tamper-resistant and non-forgeable. Generally, a blockchain system has a plurality of blockchain nodes. In addition, because there is no centralized management organization in the blockchain, the blockchain nodes need to reach a consensus on information about each block, for example, each blockchain node stores same blockchain information. Depending on features of a blockchain technology, the blockchain can be used as a unified trusted platform to implement historical event tracing and/or automatic network management. For example, the blockchain may implement at least one of the following functions: log auditing, automatic settlement, secure access and verification, or the like.

It may be understood that, in embodiments of this application, the blockchain may be alternatively named in another manner, for example, a distributed ledger or a ledger. This is not limited.

### 2. Terminal

In embodiments of this application, a terminal is a device having a wireless transceiver function. The terminal may be deployed on land, including an indoor device, an outdoor device, a handheld device, or a vehicle-mounted device; or may be deployed on water (for example, on a ship); or may be deployed in the air (for example, on a plane, a balloon, or a satellite). The terminal may also be referred to as a terminal device. The terminal device may be user equipment (UE). The UE includes a handheld device, a vehicle-mounted device, a wearable device, or a computing device having a wireless communication function. For example, the UE may be a mobile phone, a tablet computer, or a computer having a wireless transceiver function. Alternatively, the terminal device may be a virtual reality (VR) terminal device, an augmented reality (AR) terminal device, a wireless terminal in industrial control, a wireless terminal in self-driving, a wireless terminal in telemedicine, a wireless terminal in a smart grid, a wireless terminal in a smart city, a wireless terminal in a smart home, or the like.

By way of example but not limitation, the terminal in this application may be a wearable device. The wearable device may also be referred to as a wearable intelligent device, and is a general term of a wearable device that is intelligently designed and developed for daily wear by using a wearable technology, for example, glasses, gloves, a watch, clothing, and shoes. The wearable device is a portable device that can be directly worn on the body or integrated into clothes or an accessory of a user. For example, the wearable device is not only a hardware device, but also a device that implements a powerful function through software support, data exchange, and cloud interaction. In a broad sense, intelligent wearable devices include full-featured and large-size devices that can implement complete or partial functions without depending on smartphones, for example, smart watches or smart glasses, and include devices that are dedicated to only one type of application function and that need to be used together with other devices such as the smartphones, for example, various smart bands or smart jewelry used for monitoring physical signs.

In this application, the terminal may be a terminal in an internet of things (IoT) system. An IoT is an important component in development of future information technologies. A main technical feature of the IoT is to connect an object to a network by using a communication technology, to implement an intelligent network of human-machine interconnection and thing-thing interconnection. The terminal in this application may be a terminal in machine type communication (MTC). The terminal in this application may be a vehicle-mounted module, a vehicle-mounted assembly, a vehicle-mounted component, a vehicle-mounted chip, or a vehicle-mounted unit that is built in a vehicle as one or more components or units. The vehicle uses the vehicle-mounted module, the vehicle-mounted assembly, the vehicle-mounted component, the vehicle-mounted chip, or the vehicle-mounted unit that is built in the vehicle, to implement a method in this application.

### 3. Key Providing Apparatus

In embodiments of this application, a key providing apparatus may be any device having a computing function, and can provide a key for another device or apparatus. For example, the key providing apparatus may provide, for a terminal, a key for authentication (or authorization) with a network. The key providing apparatus may be maintained by a manufacturer of the terminal, or may be maintained by a third party other than the manufacturer of the terminal. This is not limited.

The following describes implementations of embodiments of this application in detail with reference to the accompanying drawings.

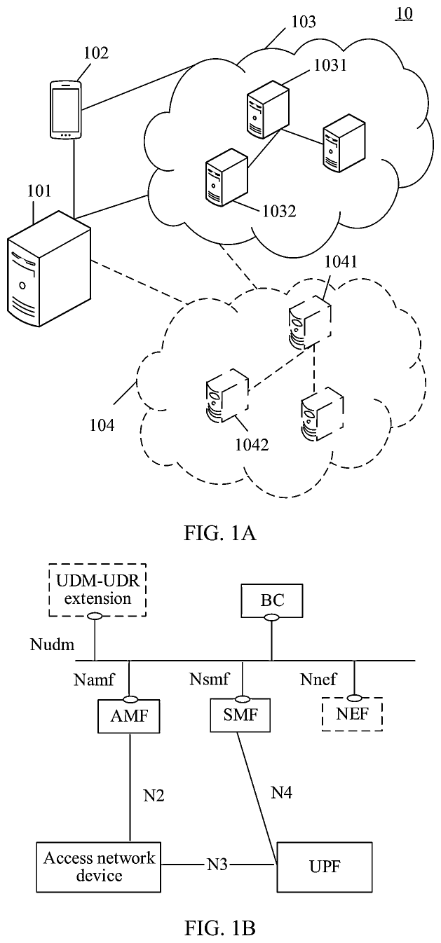

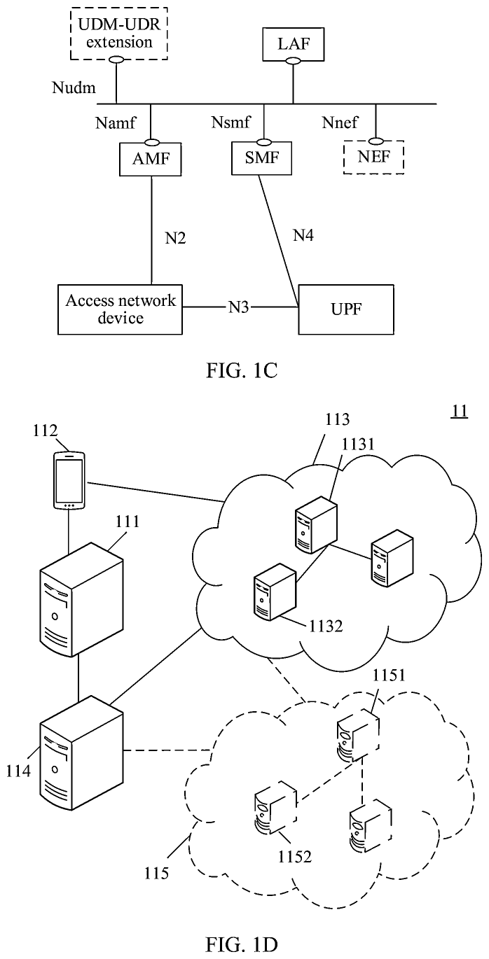

The method provided in embodiments of this application is applicable to various communication systems in which a key can be obtained. The following uses communication systems shown in FIG. 1A and FIG. 1D as examples to describe the method provided in embodiments of this application. FIG. 1A and FIG. 1D are merely diagrams, and do not constitute a limitation on scenarios to which the technical solutions provided in this application are applicable.

FIG. 1A is a diagram of an architecture of a communication system 10 according to an embodiment of this application. In FIG. 1A, the communication system 10 may include a node 101, and a terminal 102 and a network 103 that can communicate with the node 101.

The network 103 may include at least one node. The node 101 and the terminal 102 may communicate with the network 103 through a node in the network 103. For example, the node 101 may communicate with the network 103 through a node 1031 in the network 103, and the terminal 102 may communicate with the network 103 through a node 1032 in the network 103.

In FIG. 1A, the network 103 may provide a service for the terminal 102. For example, the network 103 is a network of an operator, and may provide a wireless access service for the terminal 102. It should be understood that, the network 103 may alternatively be another type of network, for example, a wireless local area network. This is not limited. The node 101 may provide, for the terminal 102 and the network 103, a key for communication between the terminal 102 and the network 103. The node 101 may be a key providing apparatus. For descriptions of the terminal and the key providing apparatus, refer to the foregoing descriptions of the technical terms in embodiments of this application. Details are not described herein again.

In an embodiment, the node 101 is a blockchain node, and/or the node 1031 is a blockchain node. In an embodiment, the communication system 10 may include any one of the following scenarios: Scenario 1: The node 101 is a blockchain node, and the node 1031 is a blockchain node. Scenario 2: The node 101 is not a blockchain node, and the node 1031 is a blockchain node. Scenario 3: The node 101 is a blockchain node, and the node 1031 is not a blockchain node. The following separately describes the foregoing scenarios.

Scenario 1: The node 101 is a blockchain node, and the node 1031 is a blockchain node.

In the scenario 1, an architecture of the network 103 may be shown in FIG. 1B. In FIG. 1i, the network includes an access and mobility management function (AMF) network element, a session management function (SMF) network element, a user plane function (UPF) network element, an access network device, and a blockchain (BC) network element. In an embodiment, the network further includes a unified data management (UDM)-unified data repository (UDR) extension network element, a network exposure function (NEF) network element, and/or the like. It may be understood that, FIG. 1B is merely a diagram of the network. In application, the network may include more or fewer network elements than those shown in FIG. 1B. This is not limited. For example, the network does not include the UDM-UDR extension network element, but includes a UDM network element and/or a UDR network element.

In the scenario 1, a network element corresponding to the node 1031 in FIG. 1B is the BC network element, that is, the node 101 may communicate with the network 103 through the BC network element. If the terminal 102 communicates with the network 103 through the node 1032, a network element corresponding to the node 1032 in FIG. 1B is the access network device.

Scenario 2: The node 101 is not a blockchain node, and the node 1031 is a blockchain node.

In the scenario 2, a network architecture of the network 103 may be shown in FIG. 1B. A network element corresponding to the node 1031 in FIG. 1B is the BC network element, that is, the node 101 may communicate with the network 103 through the BC network element. If the terminal 102 communicates with the network 103 through the node 1032, a network element corresponding to the node 1032 in FIG. 1B is the access network device.

Scenario 3: The node 101 is a blockchain node, and the node 1031 is not a blockchain node.

In the scenario 3, a network architecture of the network 103 may be shown in FIG. 1C. In FIG. 1C, the network includes an AMF network element, an SMF network element, a UPF network element, an access network device, and a ledger anchor function (LAF) network element. In an embodiment, the network further includes a UDM-UDR extension network element, an NEF network element, and/or the like. It may be understood that, FIG. 1C is merely a diagram of the network. In application, the network may include more or fewer network elements than those shown in FIG. 1C. This is not limited. For example, the network does not include the UDM-UDR extension network element, but includes a UDM network element and/or a UDR network element.

In the scenario 3, a network element corresponding to the node 1031 in FIG. 1C is the LAF network element, that is, the node 101 may communicate with the network 103 through the LAF network element. If the terminal 102 communicates with the network 103 through the node 1032, a network element corresponding to the node 1032 in FIG. 1C is the access network device.

In an embodiment, the communication system 10 further includes a network 104 that can communicate with the node 101. The network 104 may provide a service for the terminal 102. For example, the network 104 is a network of an operator. When the terminal 102 moves from a coverage area of the network 103 to a coverage area of the network 104, the network 104 may provide a wireless access service for the terminal 102. The operator corresponding to the network 104 may be the same as or different from the operator corresponding to the network 103. This is not limited.

The network 104 may include at least one node. The node 101 may communicate with the network 104 through a node in the network 104, for example, a node 1041. If the terminal 102 moves from the coverage area of the network 103 to the coverage area of the network 104, the terminal 102 may also communicate with the network 104 through a node in the network 104, for example, a node 1042.

It may be understood that, the network 104 may include a blockchain node, or may not include a blockchain node. This is not limited. If the network 104 includes a blockchain node, an architecture of the network 104 may be shown in FIG. 1B. If the network 104 does not include a blockchain node, an architecture of the network 104 may be shown in FIG. 1C.

The communication system 10 shown in FIG. 1A is merely used as an example, but is not intended to limit the technical solutions of this application. One of ordinary skilled in the art should understand that, in an embodiment, the communication system 10 may further include another device, and quantities of terminals, networks, and nodes shown in FIG. 1A may alternatively be determined according to a requirement. This is not limited.

FIG. 1D is a diagram of an architecture of another communication system 11 according to an embodiment of this application. In FIG. 1D, the communication system 11 may include a node 111, a terminal 112 and a blockchain node 114 that can communicate with the node 111, and a network 113 that can communicate with the blockchain node 114.

The network 113 may include at least one node. The blockchain node 114 and the terminal 112 may communicate with the network 113 through a node in the network 113. For example, the blockchain node 114 may communicate with the network 113 through a node 1131 in the network 113, and the terminal 112 may communicate with the network 113 through a node 1132 in the network 113.

In FIG. 1D, the network 113 may provide a service for the terminal 112. For example, the network 113 is a network of an operator, and may provide a wireless access service for the terminal 112. It should be understood that, the network 113 may alternatively be another type of network, for example, a wireless local area network. This is not limited. The node 111 may provide, for the terminal 112 and the network 113, a key for communication between the terminal 112 and the network 113. The node 111 may be a key providing apparatus. For descriptions of the terminal and the key providing apparatus, refer to the foregoing descriptions of the technical terms in embodiments of this application. Details are not described herein again.

In an embodiment, at least one of the node 111 and the node 1131 is not a blockchain node. In an embodiment, the communication system 11 may include any one of the following scenarios: Scenario 4: The node 111 is not a blockchain node, and the node 1131 is not a blockchain node. Scenario 5: The node 111 is a blockchain node, and the node 1131 is not a blockchain node. Scenario 6: The node 111 is not a blockchain node, and the node 1131 is a blockchain node. The following separately describes the foregoing scenarios.

Scenario 4: The node 111 is not a blockchain node, and the node 1131 is not a blockchain node.

In the scenario 4, a network architecture of the network 113 may be shown in FIG. 1C. A network element corresponding to the node 1131 in FIG. 1C is the LAF network element, that is, the blockchain node 114 may communicate with the network 113 through the LAF network element. If the terminal 112 communicates with the network 113 through the node 1132, a network element corresponding to the node 1132 in FIG. 1C is the access network device.

Scenario 5: The node 111 is a blockchain node, and the node 1131 is not a blockchain node.

In the scenario 5, a network architecture of the network 113 may be shown in FIG. 1C. A network element corresponding to the node 1131 in FIG. 1C is the LAF network element, that is, the blockchain node 114 may communicate with the network 113 through the LAF network element. If the terminal 112 communicates with the network 113 through the node 1132, a network element corresponding to the node 1132 in FIG. 1C is the access network device.

Scenario 6: The node 111 is not a blockchain node, and the node 1131 is a blockchain node.

In the scenario 6, a network architecture of the network 113 may be shown in FIG. 1B. A network element corresponding to the node 1131 in FIG. 1B is the BC network element, that is, the blockchain node 114 may communicate with the network 113 through the BC network element. If the terminal 112 communicates with the network 113 through the node 1132, a network element corresponding to the node 1132 in FIG. 1B is the access network device.

In an embodiment, the communication system 11 further includes a network 115 that can communicate with the blockchain node 114. The network 115 may provide a service for the terminal 112. For example, the network 115 is a network of an operator. When the terminal 112 moves from a coverage area of the network 113 to a coverage area of the network 115, the network 115 may provide a wireless access service for the terminal 112. The operator corresponding to the network 115 may be the same as or different from the operator corresponding to the network 113. This is not limited.

The network 115 may include at least one node. The node 111 may communicate with the network 115 through a node in the network 115, for example, a node 1151. If the terminal 112 moves from the coverage area of the network 113 to the coverage area of the network 115, the terminal 112 may also communicate with the network 115 through a node in the network 115, for example, anode 1152.

It may be understood that, the network 115 may include a blockchain node, or may not include a blockchain node. This is not limited. If the network 115 includes a blockchain node, an architecture of the network 115 may be shown in FIG. 1B. If the network 115 does not include a blockchain node, an architecture of the network 115 may be shown in FIG. 1C.

The communication system 11 shown in FIG. 1D is merely used as an example, but is not intended to limit the technical solutions of this application. One of ordinary skilled in the art should understand that, in an embodiment, the communication system 11 may further include another device, and quantities of terminals, networks, and nodes shown in FIG. 1D may alternatively be determined according to a requirement. This is not limited.

In an embodiment, each node or device (for example, the node 101, the node 1031, the terminal 102, the node 111, the node 1131, or the terminal 112) in FIG. 1A or FIG. 1D in embodiments of this application may also be referred to as a communication apparatus, and may be a general-purpose device or a dedicated device. This is not specifically limited in embodiments of this application.

In an embodiment, a related function of each node or device in FIG. 1A or FIG. 1D in embodiments of this application may be implemented by one device, or may be jointly implemented by a plurality of devices, or may be implemented by one or more functional modules in one device. This is not specifically limited in embodiments of this application. It may be understood that, the foregoing function may be a network element in a hardware device, or may be a software function running on dedicated hardware, or a combination of hardware and software, or a virtualization function instantiated on a platform (for example, a cloud platform).

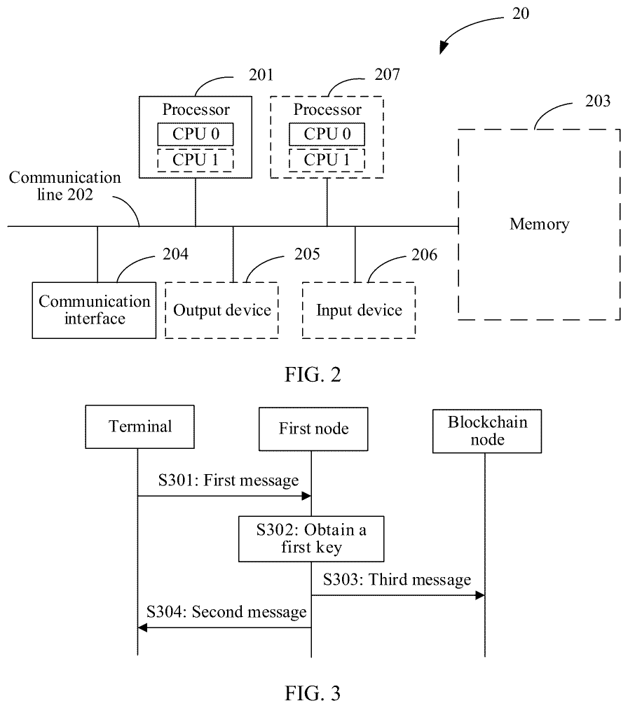

In an implementation, each node or device in FIG. 1A or FIG. 1D in embodiments of this application may use a composition structure shown in FIG. 2, or include components shown in FIG. 2. FIG. 2 is a schematic of a hardware structure of a communication apparatus 20 to which an embodiment of this application is applicable. The communication apparatus 20 includes at least one processor 201 and at least one communication interface 204, and is configured to implement the method provided in embodiments of this application. The communication apparatus 20 may further include a communication line 202 and a memory 203.

The processor 201 may be a general-purpose central processing unit (CPU), a microprocessor, an application-specific integrated circuit (ASIC), or one or more integrated circuits configured to control execution of programs in solutions of this application.

The communication line 202 may include a channel such as a bus for transmitting information between the foregoing components.

The communication interface 204 is configured to communicate with another device or a communication network. The communication interface 204 may be any apparatus such as a transceiver, for example, may be an Ethernet interface, a radio access network (RAN) interface, a wireless local area network (WLAN) interface, a transceiver, a pin, a bus, or a transceiver circuit.

The memory 203 may be a read-only memory (ROM), another type of static storage device that can store static information and instructions, a random access memory (RAM), or another type of dynamic storage device that can store information and instructions, or may be an electrically erasable programmable read-only memory (EEPROM), a compact disc read-only memory (CD-ROM) or other compact disc storage, optical disc storage (including a compact disc, a laser disc, an optical disc, a digital versatile disc, a Blu-ray disc, and the like), a magnetic disk storage medium or another magnetic storage device, or any other medium that can be configured to carry or store expected program code in a form of an instruction structure or a data structure and that is accessible to a computer, but is not limited thereto. The memory may exist independently, and is coupled to the processor 201 through the communication line 202. The memory 203 may alternatively be integrated with the processor 201. The memory provided in embodiments of this application may be usually non-volatile.

The memory 203 is configured to store computer-executable instructions for executing the solutions provided in embodiments of this application, and the processor 201 controls execution. The processor 201 is configured to execute the computer-executable instructions stored in the memory 203, to implement the method provided in embodiments of this application. Alternatively, in embodiments of this application, the processor 201 may perform processing-related functions in a method provided in the following embodiments of this application, and the communication interface 204 is responsible for communication with another device or a communication network. This is not specifically limited in embodiments of this application.

In an embodiment, the computer-executable instructions in embodiments of this application may also be referred to as application program code. This is not specifically limited in embodiments of this application.

Coupling in embodiments of this application may be indirect coupling or a communication connection between apparatuses, units, or modules in an electrical form, a mechanical form, or another form, and is used for information exchange between the apparatuses, the units, or the modules.

In an embodiment, the processor 201 may include one or more CPUs, for example, a CPU 0 and a CPU 1 in FIG. 2.

In an embodiment, the communication apparatus 20 may include a plurality of processors, for example, the processor 201 and a processor 207 in FIG. 2. Each of the processors may be a single-core (or a single-CPU) processor, or may be a multi-core (or a multi-CPU) processor. The processor herein may be one or more devices, circuits, and/or processing cores configured to process data (for example, computer program instructions).

In an embodiment, the communication apparatus 20 may further include an output device 205 and/or an input device 206. The output device 205 is coupled to the processor 201, and may display information in a plurality of manners. For example, the output device 205 may be a liquid crystal display (LCD), a light emitting diode (LED) display device, a cathode ray tube (CRT) display device, or a projector. The input device 206 is coupled to the processor 201, and may receive an input of a user in a plurality of manners. For example, the input device 206 may be a mouse, a keyboard, a touchscreen device, or a sensor device.

It may be understood that, a composition structure shown in FIG. 2 does not constitute a limitation on the communication apparatus. In addition to the components shown in FIG. 2, the communication apparatus may include more or fewer components than those shown in the figure, some components may be combined, or different component arrangements may be used.

The following describes the method provided in embodiments of this application with reference to the accompanying drawings. Network elements in the following embodiments may have the components shown in FIG. 2. Details are not described again.

It may be understood that, names of messages between network elements, names of parameters in the messages, or the like in the following embodiments of this application are merely examples, and there may be other names in an implementation. This is not specifically limited in embodiments of this application.

It may be understood that, in embodiments of this application, “/” may represent an “or” relationship between associated objects. For example, A/B may represent A or B. “And/or” may be used to describe three relationships that exist between the associated objects. For example, A and/or B may represent the following three cases: Only A exists, both A and B exist, and only B exists. A and B may be singular or plural. In addition, a representation similar to “at least one of A, B, and C” or “at least one of A, B, or C” is usually used to represent any one of the following: Only A exists; only B exists; only C exists; both A and B exist; both A and C exist; both B and C exist; and A, B, and C all exist. The foregoing uses three elements A, B, and C as an example to describe optional items of the project. When there are more elements in the representation, a meaning of the representation may be obtained according to the foregoing rule.

For ease of describing the technical solutions in embodiments of this application, in embodiments of this application, terms such as “first” and “second” may be used to distinguish between technical features with a same function or similar functions. The terms such as “first” and “second” do not limit a quantity and an execution sequence, and the terms such as “first” and “second” do not limit a definite difference. In embodiments of this application, the terms such as “example” or “for example” are used to represent an example, evidence, or a description. Any embodiment or design solution described as “example” or “for example” should not be explained as being more preferred or having more advantages than another embodiment or design solution. The term such as “example” or “for example” is used for presenting a related concept in a manner for ease of understanding.

It may be understood that, an “embodiment” used throughout this specification means that particular features, structures, or characteristics related to an embodiment are included in at least one embodiment of this application. Therefore, embodiments in the entire specification do not necessarily refer to a same embodiment. In addition, these particular features, structures, or characteristics may be combined in one or more embodiments in any appropriate manner. It may be understood that, sequence numbers of processes do not mean execution sequences in various embodiments of this application. The execution sequences of the processes should be determined based on functions and internal logic of the processes, and should not be construed as any limitation on implementation processes of embodiments of this application.

It may be understood that, in this application, “when” and “if” mean that corresponding processing is performed in an objective situation, are not intended to limit time, do not require a necessary determining action in an implementation, and do not mean any other limitation.

“Simultaneously” in this application may be understood as being at a same time point, may be understood as being within a time period, or may be understood as being within a same periodicity.

It may be understood that, in some scenarios, some optional features in embodiments of this application may be independently implemented without depending on another feature, for example, a solution on which the optional features are currently based, to resolve a corresponding technical problem and achieve corresponding effects. Alternatively, in some scenarios, the optional features may be combined with other features based on a requirement. Correspondingly, an apparatus provided in embodiments of this application may also correspondingly implement these features or functions. Details are not described herein.

It may be understood that, a same step or steps or technical features that have a same function in embodiments of this application may be mutually referenced in different embodiments.

It may be understood that, in embodiments of this application, any node and/or terminal may perform some or all steps in embodiments of this application. These steps are merely examples. In embodiments of this application, other steps or variations of various steps may alternatively be performed. In addition, the steps may be performed in a sequence different from a sequence presented in embodiments of this application, and it is possible that not all the steps in embodiments of this application need to be performed.

FIG. 3 shows a key obtaining method according to an embodiment of this application. The method may include the following operations.

S301: A terminal sends a first message to a first node. Correspondingly, the first node receives the first message from the terminal.

The terminal may be the terminal 102 in FIG. 1A, and the first node is the node 101 in FIG. 1A; or the terminal may be the terminal 112 in FIG. 1D, and the first node is the node 111 in FIG. 1D.

In an embodiment of the application, the first message may indicate that the terminal is to access a network. In this way, after receiving the first message, the first node may determine, for the terminal, the network to be accessed by the terminal, in other words, determine a target network for the terminal. The first node may further generate a key for the terminal and the target network, so that the terminal communicates with the target network. For example, the terminal performs authentication with the target network by using the generated key.

In an embodiment, the first message includes information about the target network. In this way, the terminal can indicate, to the first node, the network to be accessed by the terminal, so that the first node generates the key for the terminal and the target network, and the terminal communicates with the target network. If the terminal is the terminal 102 in FIG. 1A, and the first node is the node 101 in FIG. 1A, the target network is the network 103 in FIG. 1A. If the terminal is the terminal 112 in FIG. 1D, and the first node is the node 111 in FIG. 1D, the target network is the network 113 in FIG. 1D.

In an embodiment, the information about the target network indicates the target network. For example, the information about the target network includes an identifier of the target network.

In an embodiment, the target network is determined based on selection of a user corresponding to the terminal, or the target network is determined according to a preset policy.

For example, the user selects the target network by using software on the terminal, and in response to an operation of the user, the terminal determines the target network. Alternatively, the terminal determines the target network based on network access requirement information submitted by the user, for example, traffic requirement information and/or call duration requirement information. Alternatively, the terminal determines the target network based on environment information, for example, location information of the terminal and/or signal quality of a surrounding network measured by the terminal.

In an embodiment, the terminal further sends a second random number to the first node, so that the first node generates the key based on the second random number. Correspondingly, the first node receives the second random number from the terminal.

It may be understood that, the second random number may be included in the first message and sent to the first node, or may be sent to the first node by using another message. This is not limited.

S302: The first node obtains a first key.

In an embodiment of the application, the first key may be used for authentication between the terminal and the target network. The first key is a symmetric key.

In an embodiment, the first node generates the first key by using a key generation algorithm. Alternatively, the first node obtains the first key from another device that can generate a key.

It may be understood that, if the first node further receives the second random number, the first node generates the first key based on the key generation algorithm and the second random number.

S303: The first node sends a third message to a blockchain node. Correspondingly, the blockchain node receives the third message from the first node.

In an embodiment of the application, the third message may indicate the first key to the target network.

For example, if the blockchain node is included in the target network, the third message is obtained by encrypting the first key by using a public key of the target network (for example, a public key of a node in the target network). In this way, after receiving the third message, the target network may obtain the first key by decrypting the third message by using a private key of the target network.

For another example, if the blockchain node is not included in the target network, the third message is obtained by encrypting the first key and fourth indication information by using a public key of the blockchain node. The fourth indication information indicates the blockchain node to send the first key to the target network. For example, the fourth indication information includes the identifier of the target network. After receiving the third message, the blockchain node decrypts the third message by using a private key of the blockchain node, to obtain the first key and the fourth indication information, and sends the first key to the target network based on the fourth indication information.

In an embodiment, after receiving the third message, the blockchain node sends a response message of the third message to the first node, to indicate, to the first node, that the third message is received.

It may be understood that, in S303, the first node may trigger, in a blockchain, generation of a blockchain transaction (referred to as a first transaction for short below) corresponding to the first key. For example, if the first node is a node in the blockchain, the first node triggers the generation of the first transaction; or if the first node is not a node in the blockchain, the first node triggers the blockchain node to generate the first transaction. Subsequently, the target network may obtain the third message. For example, the target network may obtain the third message by using the blockchain. The following provides descriptions with reference to the foregoing scenario 1 to scenario 6.

For the scenario 1, the blockchain node in S303 is the node 1031 in FIG. 1A. The node 101 generates the first transaction, uses the first key as content of the first transaction, encrypts the first transaction by using a public key of the node 1031 in the blockchain, signs the first key by using a private key of the node 101 in the blockchain, to obtain the third message, and releases the third message to the blockchain. After nodes in the blockchain reach a consensus, the first transaction is stored in the blockchain. Subsequently, each node in the blockchain verifies a signature by using a public key of the node 101 in the blockchain, and decrypts the first transaction by using a private key of the node in the blockchain. If the verification and the decryption succeed, it indicates that the first transaction is related to the node, and the node can obtain the first key. In this example, the node 1031 can perform verification and decryption successfully, and obtain the first key. In this way, the target network (the network 103 in this example) obtains the first key. In an embodiment, the target network further obtains an identifier of the first transaction in the blockchain.

In an example, a format of the third message may be as follows: {EncapPK_node 1031 (TX (Initial: node 101, Receiver: node 1031, Content: first key)), Sigsk-node 101}. This may indicate that a sender of the third message is the node 101, a receiver of the third message is the node 1031, and content of the third message includes the first key. EncapPK_node 1031 (TX (Initial: node 101, Receiver: node 1031, Content: first key)) indicates information obtained by encrypting the first key by using the public key of the node 1031 in the blockchain. Sigsk-node 101 indicates information obtained by signing the first key by using the private key of the node 101 in the blockchain.

For the scenario 2, the blockchain node in S303 is the node 1031 in FIG. 1A. The node 101 encrypts the first key by using a public key of the node 1031, to obtain the third message, and sends the third message to the node 1031. After receiving the third message, the node 1031 decrypts the third message by using a private key of the node 1031, to obtain the first key. In this way, the target network (the network 103 in this example) obtains the first key. Subsequently, the node 1031 generates the first transaction, uses the first key as content of the first transaction, encrypts the first transaction, and releases an encrypted message to the blockchain. After nodes in the blockchain reach a consensus, the first transaction is stored in the blockchain. It may be understood that, after the first transaction is stored in the blockchain, the target network may obtain the identifier of the first transaction in the blockchain.

For the scenario 3, the blockchain node in S303 is a node other than the node 101 in the blockchain, for example, a blockchain node corresponding to the target network (the network 103 in this example). The blockchain node corresponding to the target network may be understood as a node that can communicate with the target network in the blockchain. The node 101 generates the first transaction, uses the first key and the fourth indication information as content of the first transaction, encrypts the first transaction by using a public key of the blockchain node corresponding to the network 103 in the blockchain, signs the first key by using a private key of the node 101 in the blockchain, to obtain the third message, and releases the third message to the blockchain. After nodes in the blockchain reach a consensus, the first transaction is stored in the blockchain. Subsequently, each node in the blockchain verifies a signature by using the public key of the node 101 in the blockchain, and decrypts the first transaction by using a private key of the node in the blockchain. If the verification and the decryption succeed, it indicates that the first transaction is related to the node, and the node can obtain the first key and the fourth indication information. It should be understood that, in this example, the blockchain node corresponding to the network 103 can perform verification and decryption successfully, obtain the first key and the fourth indication information, encrypt the first key by using the public key of the node 1031, and send encrypted information to the node 1031 based on the fourth indication information. The node 1031 receives the encrypted information, and decrypts the information by using the private key of the node 1031, to obtain the first key. In this way, the target network obtains the first key. In an embodiment, the blockchain node corresponding to the network 103 further obtains the identifier of the first transaction in the blockchain, and sends the identifier of the first transaction to the node 1031. In this way, the target network can obtain the identifier of the first transaction.

In an example, a format of the third message is as follows: {EncapPK_blockchain node corresponding to the network 103 (TX (Initial: node 101, Receiver: blockchain node corresponding to the network 103, Content: first key and fourth indication information)), Sigsk-node 101}. This may indicate that a sender of the third message is the node 101, a receiver of the third message is the blockchain node corresponding to the network 103, and content of the third message includes the first key and the fourth indication information. EncapPK_blockchain node corresponding to the network 103 (TX (Initial: node 101, Receiver: blockchain node corresponding to the network 103, Content: first key and fourth indication information)) indicates information obtained by encrypting the first key and the fourth indication information by using the public key of the blockchain node corresponding to the network 103 in the blockchain. Sigsk-node 101 indicates information obtained by signing the first key by using the private key of the node 101 in the blockchain.

For the scenario 4, the blockchain node in S303 is the blockchain node 114 in FIG. 1D. The blockchain node 114 is a blockchain node corresponding to the node 111, that is, a node that can communicate with the node 111 in the blockchain. The node 111 encrypts the first key and the fourth indication information by using a public key of the blockchain node 114, to obtain the third message, and sends the third message to the blockchain node 114. After receiving the third message, the blockchain node 114 decrypts the third message by using a private key of the blockchain node 114, to obtain the first key and the fourth indication information. Subsequently, the blockchain node 114 generates the first transaction, uses the first key and the fourth indication information as content of the first transaction, encrypts the first transaction by using a public key of a blockchain node corresponding to the network 113 in the blockchain, signs the first key by using the private key of the blockchain node 114 in the blockchain, to obtain a message 1, and releases the message 1 to the blockchain. After nodes in the blockchain reach a consensus, the first transaction is stored in the blockchain. Subsequently, each node in the blockchain verifies a signature by using the public key of the blockchain node 114 in the blockchain, and decrypts the first transaction by using a private key of the node in the blockchain. If the verification and the decryption succeed, it indicates that the first transaction is related to the node, and the node can obtain the first key and the fourth indication information. In this example, the blockchain node corresponding to the network 113 can perform verification and decryption successfully, obtain the first key and the fourth indication information, encrypt the first key by using a public key of the node 1131, and send encrypted information to the node 1131 based on the fourth indication information. The node 1131 receives the encrypted information, and decrypts the information by using a private key of the node 1131, to obtain the first key. In this way, the target network (the network 113 in this example) obtains the first key. In an embodiment, the blockchain node corresponding to the network 113 obtains the identifier of the first transaction in the blockchain, and sends the identifier of the first transaction to the node 1131. In this way, the target network can obtain the identifier of the first transaction.

For the scenario 5, the blockchain node in S303 is the blockchain node 114 in FIG. 1D. The blockchain node 114 is a blockchain node corresponding to the target network (the network 113 in this example), that is, a node that can communicate with the target network in the blockchain. The node 111 generates the first transaction, uses the first key and the fourth indication information as content of the first transaction, encrypts the first transaction by using a public key of the blockchain node corresponding to the network 113 in the blockchain, signs the first key by using a private key of the node 111 in the blockchain, to obtain the third message, and releases the third message to the blockchain. After nodes in the blockchain reach a consensus, the first transaction is stored in the blockchain. Subsequently, each node in the blockchain verifies a signature by using a public key of the node 111 in the blockchain, and decrypts the first transaction by using a private key of the node in the blockchain. If the verification and the decryption succeed, it indicates that the first transaction is related to the node, and the node can obtain the first key and the fourth indication information. It should be understood that, the blockchain node corresponding to the network 113 can perform verification and decryption successfully, obtain the first key and the fourth indication information, encrypt the first key by using a public key of the node 1131, and send encrypted information to the node 1131 based on the fourth indication information. The node 1131 receives the encrypted information, and decrypts the information by using a private key of the node 1131, to obtain the first key. In this way, the target network obtains the first key. In an embodiment, the blockchain node corresponding to the network 113 obtains the identifier of the first transaction in the blockchain, and sends the identifier of the first transaction to the node 1131. In this way, the target network can obtain the identifier of the first transaction.

In an example, a format of the third message is as follows: {EncapPK_blockchain node corresponding to the network 113 (TX (Initial: node 111, Receiver: blockchain node corresponding to the network 113, Content: first key and fourth indication information)), Sigsk-node 111}. This may indicate that a sender of the third message is the node 111, a receiver of the third message is the blockchain node corresponding to the network 113, and content of the third message includes the first key and the fourth indication information. EncapPK_blockchain node corresponding to the network 113 (TX (Initial: node 111, Receiver: blockchain node corresponding to the network 113, Content: first key and fourth indication information)) indicates information obtained by encrypting the first key and the fourth indication information by using the public key of the blockchain node corresponding to the network 113 in the blockchain. Sigsk-node 111 indicates information obtained by signing the first key by using the private key of the node 111 in the blockchain.

For the scenario 6, the blockchain node in S303 is the blockchain node 114 in FIG. 1D. The blockchain node 114 is a blockchain node corresponding to the node 111, that is, a node that can communicate with the node 111 in the blockchain. The node 111 encrypts the first key and the fourth indication information by using a public key of the blockchain node 114, to obtain the third message, and sends the third message to the blockchain node 114. After receiving the third message, the blockchain node 114 decrypts the third message by using a private key of the blockchain node 114, to obtain the first key and the fourth indication information. Subsequently, the blockchain node 114 generates the first transaction, uses the first key as content of the first transaction, encrypts the first transaction by using a public key of the node 1131 in the blockchain, signs the first key by using the private key of the blockchain node 114 in the blockchain, to obtain a message 2, and releases the message 2 to the blockchain. After nodes in the blockchain reach a consensus, the first transaction is stored in the blockchain. Subsequently, each node in the blockchain verifies a signature by using the public key of the blockchain node 114 in the blockchain, and decrypts the first transaction by using a private key of the node in the blockchain. If the verification and the decryption succeed, it indicates that the first transaction is related to the node, and the node can obtain the first key. In this example, the node 1131 can perform verification and decryption successfully, and obtain the first key. In this way, the target network (the network 113 in this example) obtains the first key. In an embodiment, the target network further obtains the identifier of the first transaction in the blockchain.

It may be understood that, the foregoing formats of the third message are merely examples. In application, the message may include more or less information than that in the foregoing example. This is not limited. For example, in the scenario 3, the third message may not include the fourth indication information, but implicitly indicates the blockchain node corresponding to the network 103 to send the first key to the node 1031.

In an embodiment, the first node further obtains the identifier of the first transaction. For example, if the first node is a node in the blockchain, the first node directly obtains the identifier of the first transaction in the blockchain; or if the first node is not a node in the blockchain, the first node receives the identifier of the first transaction from the blockchain node.

In an embodiment, the identifier of the first transaction includes an address of the first transaction, or the identifier of the first transaction includes an address of the first transaction and a sequence number of the terminal in the first transaction. The address of the first transaction is an address of the first transaction in the blockchain.

It may be understood that, if the first transaction includes information about a single terminal, the identifier of the first transaction includes the address of the first transaction. If the first transaction includes information about a plurality of terminals, the identifier of the first transaction includes the address of the first transaction and the sequence number of the terminal in the first transaction. In this way, an identifier of a transaction corresponding to a key configured by the first node for each terminal can be unique.

In an example, if the first transaction includes a key corresponding to a terminal 1, the address of the first transaction may be used as the identifier of the first transaction. If the first transaction includes {sequence number 1: key corresponding to a terminal 1, sequence number 2: key corresponding to a terminal 2}, for the terminal 1, the sequence number 1 may be added after the address of the first transaction as the identifier of the first transaction, and for the terminal 2, the sequence number 2 may be added after the address of the first transaction as the identifier of the first transaction.

S304: The first node sends a second message to the terminal. Correspondingly, the terminal receives the second message from the first node.

In an embodiment of the application, the second message may include key information. The key information is determined based on the first key. After receiving the second message, the terminal may determine the first key based on the key information. In an embodiment, the second message further includes the identifier of the first transaction and at least one of the following: the identifier of the target network or the public key of the target network.

In an embodiment, the key information includes the first key, or the key information is the first key. In other words, the first node may include the first key in the second message and send the second message to the terminal. After receiving the second message, the terminal may obtain the first key, and the first node further sends the first key to the target network by using the blockchain. In this way, authentication can be performed between the terminal and the target network based on the first key.

In another possible implementation, the key information includes a third key, or the key information is a third key. The third key is determined based on the first key. In other words, the first node first obtains the third key, generates the first key based on the third key, sends the first key to the target network by using the blockchain, and sends the third key to the terminal. After receiving the third key, the terminal may generate the first key based on the third key. In this way, authentication can be performed between the terminal and the target network by using the first key. In addition, the target network can obtain the first key, but cannot obtain the third key. Therefore, the third key can be hidden and protected as a root key that derives the first key. Subsequently, the first node may further update an authentication key between the terminal and the target network based on the third key, or configure an authentication key for the terminal and another network based on the third key. This not only facilitates operation, but also improves communication security between the terminal and the network.

In an embodiment, the first key is obtained based on the third key and the identifier of the target network; or the first key is obtained based on the third key, the identifier of the target network, and the second random number. In other words, the first node and the terminal may perform calculation on the third key and the identifier of the target network by using the key generation algorithm to obtain the first key, or perform calculation on the third key, the identifier of the target network, and the second random number by using the key generation algorithm to obtain the first key.

In an embodiment, the first node performs remote provisioning on the terminal over a security interface, and writes content included in the second message into the terminal.

In an example, the second message includes: HTTPS: UE-Root_Key, Target-OP-profile (IDOP, PKOP), and TX-addr. UE-Root_Key is the third key, Target-OP-profile is the information about the target network, IDOP is the identifier of the target network, PKOP is the public key of the target network, and TX-addr is the identifier of the first transaction.

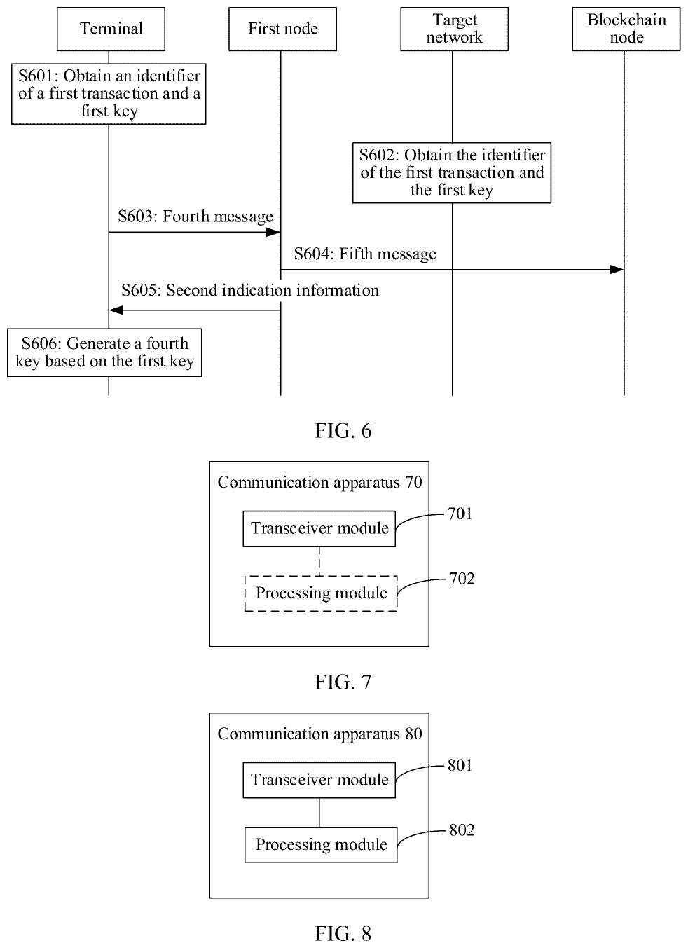

In an embodiment, after S304, the terminal may update the key according to a method shown in FIG. 6.

The actions of the terminal, the first node, or the target network (which may be the node in the target network) in S301 to S304 may be performed by the processor 201 in the communication apparatus 20 shown in FIG. 2 by invoking the application program code stored in the memory 203. This is not limited in embodiments of this application.

Based on the method shown in FIG. 3, the terminal may trigger the first node to configure the first key for the terminal and the target network. Subsequently, the terminal and the target network may perform authentication or authorization based on the first key, so that the terminal accesses the target network. In this way, the terminal and the target network do not need to perform authentication or authorization by using a key in a SIM card, so that the SIM card and the network are unbound. If the user expects to switch the network, the user does not need to replace the SIM card, so that the terminal can flexibly access a network, thereby improving user experience.

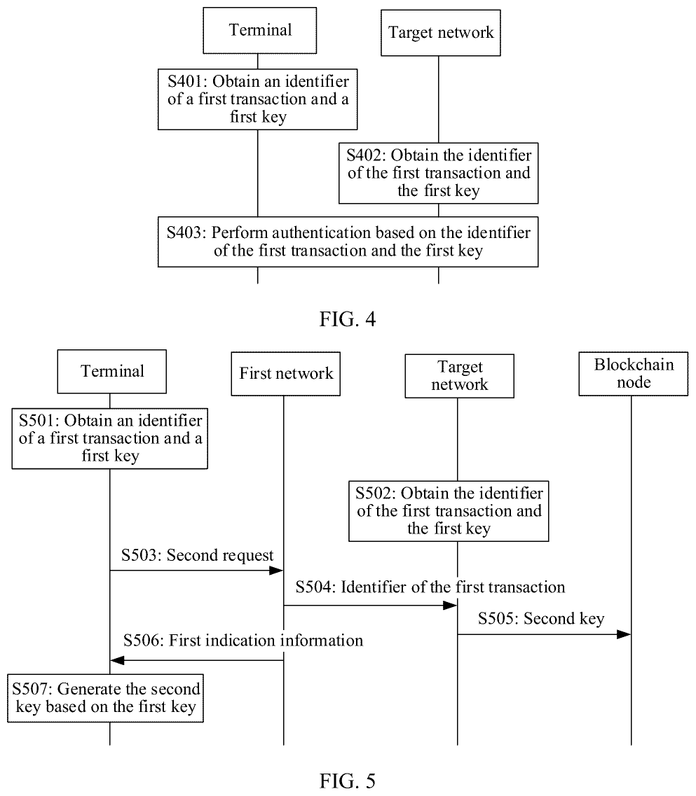

FIG. 4 shows an authentication method according to an embodiment of this application. The authentication method may include the following operations.

S401: A terminal obtains an identifier of a first transaction and a first key.

The terminal may be the terminal 102 in FIG. 1A; or the terminal may be the terminal 112 in FIG. 1D. The first transaction is a blockchain transaction corresponding to the first key. The first key may be used for authentication between the terminal and a target network.

It may be understood that, if the terminal is the terminal 102 in FIG. 1A, the target network may be the network 103 in FIG. 1A; or if the terminal is the terminal 112 in FIG. 1D, the target network may be the network 113 in FIG. 1D.

In an embodiment, the terminal obtains the identifier of the first transaction and the first key by using the method shown in FIG. 3. For example, the terminal receives a second message from a first node, where the second message includes key information and the identifier of the first transaction. Alternatively, the key information and the identifier of the first transaction may be separately included in different messages. This is not limited. Alternatively, the terminal obtains the identifier of the first transaction and the first key in another manner. This is not limited.

S402: The target network obtains the identifier of the first transaction and the first key.

It may be understood that, S402 may be performed by a second node in the target network. For example, if the target network is the network 103 in FIG. 1A, the node 1031 obtains the identifier of the first transaction and the first key, in other words, the second node is the node 1031; or if the target network is the network 113 in FIG. 1D, the node 1131 obtains the identifier of the first transaction and the first key, in other words, the second node is the node 1131.

In an embodiment, the target network obtains the identifier of the first transaction and the first key by using the method shown in FIG. 3. For example, the target network obtains the identifier of the first transaction and the first key in a blockchain, or the target network obtains the identifier of the first transaction and the first key from a blockchain node or the first node. Alternatively, the target network obtains the identifier of the first transaction and the first key in another manner. This is not limited.

It may be understood that, an execution sequence of S401 and S402 is not limited in this application. For example, S401 may be performed before S402, or S402 may be performed before S401, or S401 and S402 are performed simultaneously.

S403: The terminal and the target network perform authentication based on the identifier of the first transaction and the first key.

It may be understood that, S403 may be performed by a third node in the target network. For example, if the target network is the network 103 in FIG. 1A, authentication is performed between the terminal and the node 1032 based on the identifier of the first transaction and the first key, in other words, the third node is the node 1032; or if the target network is the network 113 in FIG. 1D, authentication is performed between the terminal and the node 1132 based on the identifier of the first transaction and the first key, in other words, the third node is the node 1132. In the foregoing example, the second node is different from the third node. However, in application, the second node may alternatively be the same as the third node. This is not limited.

In an embodiment, the terminal sends a first request to the target network. The first request may be used for requesting to access the target network. After receiving the first request, the target network sends an authentication message to the terminal. The authentication message is obtained based on the first key, or it may be described as that the authentication message corresponds to the first key. In this way, after receiving the authentication message, the terminal can verify the authentication message.

In an embodiment of the application, the first request may include the identifier of the first transaction. In this way, after receiving the first request, the target network can obtain the first key based on the identifier of the first transaction, for example, find the first key by using the identifier of the first transaction as an index.

In an embodiment, the terminal further sends an identifier of the terminal to the target network, to indicate, to the target network, the terminal that is to perform authentication. It may be understood that, the identifier of the terminal may be included in the first request and sent to the target network, or the identifier of the terminal may be included in another message and sent to the target network. This is not limited.

In an example, the terminal encrypts the identifier of the first transaction by using a public key of the target network, to obtain the first request, and sends the first request to the target network. After receiving the first request, the target network decrypts the first request by using a private key of the target network, obtains the identifier of the first transaction, obtains the first key based on the identifier of the first transaction, obtains the authentication message based on the first key and the identifier of the target network, and sends the authentication message to the terminal. After receiving the authentication message, the terminal verifies the authentication message based on the first key and the identifier of the target network.

In another example, the terminal encrypts the identifier of the first transaction and the identifier of the terminal by using the public key of the target network, to obtain the first request, and sends the first request to the target network. After receiving the first request, the target network decrypts the first request by using a private key of the target network, obtains the identifier of the first transaction and the identifier of the terminal, obtains the first key based on the identifier of the first transaction, obtains the authentication message based on the first key, the identifier of the target network (which may be replaced with a sequence number of the target network), and a third random number generated by the target network, and sends the authentication message and the third random number to the terminal. After receiving the authentication message and the third random number, the terminal verifies the authentication message based on the first key, the identifier of the target network, and the third random number.

In an embodiment, after obtaining the identifier of the first transaction based on the first request, the target network may query the target network for the first key based on the identifier of the first transaction.

For example, before S403, the third node obtains the identifier of the first transaction and the first key from the second node. After obtaining the identifier of the first transaction based on the first request, the third node may locally find the first key based on the identifier of the first transaction. Alternatively, after obtaining the identifier of the first transaction based on the first request, the third node sends the identifier of the first transaction to the second node. After receiving the identifier of the first transaction, the second node locally finds the first key based on the identifier of the first transaction, and sends the first key to the third node.

In an embodiment, the target network verifies the identifier of the first transaction by using the blockchain.

For example, the target network sends a query message to the blockchain node. The query message may be used for querying for a key corresponding to the first transaction. For example, the query message may include the identifier of the first transaction. After receiving the query message, the blockchain node may query for the first key based on the identifier of the first transaction, and send a response message to the target network. The response message includes the first key. After receiving the response message, the target network verifies whether a first key found by the target network is the same as the first key sent by the blockchain node, and if the first key found by the target network is the same as the first key sent by the blockchain node, the target network sends the authentication message to the terminal; or if the first key found by the target network is different from the first key sent by the blockchain node, the target network sends an authentication failure message to the terminal.

In an embodiment, after verifying the authentication message, the terminal sends a verification result to the target network. Correspondingly, the target network receives the verification result from the terminal. The verification result includes a verification failure or a verification success.

In an embodiment, after receiving the verification result, the target network sends a verification response message to the terminal based on the verification result. Correspondingly, the terminal receives the verification response message from the target network. The verification response message may indicate that the authentication succeeds or the authentication fails, or the verification response message may indicate that access to the target network is allowed or access to the target network is not allowed.

The actions of the terminal or the target network (which may be the node in the target network) in S401 to S403 may be performed by the processor 201 in the communication apparatus 20 shown in FIG. 2 by invoking the application program code stored in the memory 203. This is not limited in embodiments of this application.

Based on the method shown in FIG. 4, authentication may be performed between the terminal and the target network based on the identifier of the first transaction and the first key. In this way, the target network does not need to allocate a subscription permanent identifier (SUPI) to each terminal, and the target network does not need to manage a large quantity of SUPIs. This simplifies an authentication process, and saves storage resources of the target network.

FIG. 5 shows another key obtaining method according to an embodiment of this application. The method may include the following operations.
S501: A terminal obtains an identifier of a first transaction and a first key.
S502: A target network obtains the identifier of the first transaction and the first key.
S501 and S502 are the same as S401 and S402 in the method shown in FIG. 4. For related descriptions, refer to the method shown in FIG. 4. Details are not described herein again.
S503: The terminal sends a second request to a first network. Correspondingly, the first network receives the second request from the terminal.

In an embodiment, the target network is a network at a home location of the terminal, and the first network is a network at a roaming location of the terminal.

Example 1: The communication system 10 shown in FIG. 1A is used as an example. The first network is the network 104. After moving from the coverage area of the network 103 to the coverage area of the network 104, the terminal 102 sends the second request to the network 104, for example, sends the second request to the node 1042.

Example 2: The communication system 11 shown in FIG. 1D is used as an example. The first network is the network 115. After moving from the coverage area of the network 113 to the coverage area of the network 115, the terminal 112 sends the second request to the network 115, for example, sends the second request to the node 1152.

In an embodiment of the application, the second request may be used for requesting to access the first network. The second request may include the identifier of the first transaction and the identifier of the target network.

In an embodiment, the terminal further sends a first random number to the first network. Correspondingly, the first network receives the first random number from the terminal. It may be understood that, the first random number may be included in the second request and sent to the first network, or may be included in another message and sent to the first network. This is not limited.

S504: The first network sends the identifier of the first transaction to the target network. Correspondingly, the target network receives the identifier of the first transaction from the first network.

In an embodiment, the first network determines, based on the identifier of the target network, to send the identifier of the first transaction to the target network. After receiving the identifier of the first transaction, the target network obtains the first key based on the identifier of the first transaction.

For the foregoing example 1, after receiving the second request, the node 1042 sends the identifier of the first transaction to the node 1032 based on an identifier of the network 103. After receiving the identifier of the first transaction, the node 1032 performs query based on the identifier of the first transaction, to obtain the first key.

For the foregoing example 2, after receiving the second request, the node 1152 sends the identifier of the first transaction to the node 1132 based on an identifier of the network 113. After receiving the identifier of the first transaction, the node 1132 performs query based on the identifier of the first transaction, to obtain the first key.

In an embodiment, the first network sends the first random number to the target network. Correspondingly, the target network receives the first random number from the first network.

In an embodiment, the first network sends an identifier of the first network to the target network. Correspondingly, the target network receives the identifier of the first network from the first network.

In an embodiment, the first network sends the identifier of the target network to the target network. Correspondingly, the target network receives the identifier of the target network from the first network.

It may be understood that, the identifier of the first transaction, the first random number, the identifier of the first network, and the identifier of the target network may be included in one message and sent to the target network, or may be separately included in different messages and sent to the target network. This is not limited.

S505: The target network sends a second key to a blockchain node. Correspondingly, the blockchain node receives the second key from the target network.

In an embodiment, the second key may be used for authentication between the terminal and the first network. The second key is obtained based on the first key.

For the foregoing example 1, the node 1032 obtains the second key based on the first key. For example, the node 1032 performs calculation on the first key by using a key generation algorithm, to obtain the second key; or performs calculation on the first key and an identifier of the network 104 by using a key generation algorithm, to obtain the second key; or performs calculation on the first key, an identifier of the network 104, and the first random number by using a key generation algorithm, to obtain the second key; and sends the second key to the blockchain node. For example, after obtaining the second key, the node 1032 sends the second key to the node 1031. After receiving the second key, the node 1031 sends the second key to the blockchain node.

For the foregoing example 2, the node 1132 obtains the second key based on the first key. For example, the node 1132 performs calculation on the first key by using the key generation algorithm, to obtain the second key; or performs calculation on the first key and an identifier of the network 115 by using the key generation algorithm, to obtain the second key; or performs calculation on the first key, an identifier of the network 115, and the first random number by using the key generation algorithm, to obtain the second key; and sends the second key to the blockchain node. For example, after obtaining the second key, the node 1132 sends the second key to the node 1131. After receiving the second key, the node 1131 sends the second key to the blockchain node.

It may be understood that, in S505, the target network may trigger, in a blockchain, generation of a blockchain transaction (referred to as a second transaction for short below) corresponding to the second key. For example, if the node 1031 or the node 1131 is a node in the blockchain, the node 1031 or the node 1131 triggers generation of the second transaction; or if the node 1031 or the node 1131 is not a node in the blockchain, the node 1031 or the node 1131 triggers the blockchain node to generate the second transaction. Subsequently, the first network may obtain the second key by using the blockchain. In an embodiment, the first network further obtains an identifier of the second transaction. The foregoing process is similar to the process in which the first node sends the third message to the blockchain node in S303. For details, refer to the corresponding descriptions in S303. Details are not described herein again.

In an embodiment, the identifier of the second transaction includes an address of the second transaction, or the identifier of the second transaction includes an address of the second transaction and a sequence number of the terminal in the second transaction. The address of the second transaction is an address of the second transaction in the blockchain.

S506: The first network sends first indication information to the terminal. Correspondingly, the terminal receives the first indication information from the first network.

In an embodiment of the application, the first indication information may indicate the terminal to generate the second key, or indicate the terminal to generate a new key.

For the foregoing example 1, the node 1032 sends the first indication information to the terminal 102. For the foregoing example 2, the node 1132 sends the first indication information to the terminal 112.

In an embodiment, the first network further sends the identifier of the second transaction to the terminal. Correspondingly, the terminal receives the identifier of the second transaction from the first network.

It may be understood that, the identifier of the second transaction and the first indication information may be included in one message and sent to the terminal, or may be separately included in different messages and sent to the terminal. This is not limited.

S507: The terminal generates the second key based on the first key.

For the foregoing example 1, the terminal 102 obtains the second key based on the first key. For example, the terminal 102 performs calculation on the first key by using the key generation algorithm, to obtain the second key; or performs calculation on the first key and the identifier of the network 104 by using the key generation algorithm, to obtain the second key; or performs calculation on the first key, the identifier of the network 104, and the first random number by using the key generation algorithm, to obtain the second key.

For the foregoing example 2, the terminal 112 obtains the second key based on the first key. For example, the terminal 112 performs calculation on the first key by using the key generation algorithm, to obtain the second key; or performs calculation on the first key and the identifier of the network 115 by using the key generation algorithm, to obtain the second key; or performs calculation on the first key, the identifier of the network 115, and the first random number by using the key generation algorithm, to obtain the second key.

It may be understood that, after S507, the terminal and the first network may obtain the second key and the identifier of the second transaction.

In an embodiment, after S507, the terminal and the first network may perform authentication based on the second key and the identifier of the second transaction. For details, refer to the corresponding descriptions in S403.

In an embodiment, after S507, the terminal may update the key according to a method shown in FIG. 6.

The actions of the terminal, the target network (which may be a node in the target network), or the first network (which may be the node in the first network) in S501 to S507 may be performed by the processor 201 in the communication apparatus 20 shown in FIG. 2 by invoking the application program code stored in the memory 203. This is not limited in embodiments of this application.

Based on the method shown in FIG. 5, the target network may configure the second key for the first network and the terminal. Subsequently, the terminal and the first network may perform authentication or authorization based on the second key, and the target network does not need to participate in the authentication, so that an authentication procedure is simplified.

FIG. 6 shows a key update method according to an embodiment of this application. The method may include the following operations.
S601: A terminal obtains an identifier of a first transaction and a first key.
S602: A target network obtains the identifier of the first transaction and the first key.
S601 and S602 are the same as S401 and S402 in the method shown in FIG. 4. For related descriptions, refer to the method shown in FIG. 4. Details are not described herein again.
S603: The terminal sends a fourth message to a first node. Correspondingly, the first node receives the fourth message from the terminal.

If the terminal is the terminal 102 in FIG. 1A, the first node is the node 101 in FIG. 1A; or if the terminal is the terminal 112 in FIG. 1D, the first node is the node 111 in FIG. 1D.

In an embodiment of the application, the fourth message may indicate a second network. For example, the fourth message includes an identifier of the second network. The second network and the target network may be the same or may be different. For example, the second network is the network 103 or the network 104 in FIG. 1A; or the second network is the network 113 or the network 115 in FIG. 1D.

It may be understood that, if the second network is the same as the target network, it indicates that the terminal triggers update of a key for authentication between the terminal and the target network. If the second network is different from the target network, it indicates that the terminal is to switch to the second network, and the terminal triggers the first node to configure a key for authentication for the terminal and the second network.

It may be understood that, the method shown in FIG. 6 may not include S603. In this case, the first node may trigger update of the key.

In an embodiment, the terminal sends a fourth random number to the first node. Correspondingly, the first node receives the fourth random number from the terminal.

It may be understood that, the fourth random number is included in the fourth message and sent to the first node, or the fourth random number is included in a message different from the fourth message and sent to the first node.

S604: The first node sends a fifth message to a blockchain node. Correspondingly, the blockchain node receives the fifth message from the first node.

In an embodiment of the application, the fifth message includes a fourth key. The fourth key may be used for authentication between the terminal and the second network.

It may be understood that, after receiving the fourth message, the first node generates the fourth key based on the first key. For example, the first node performs calculation on the first key by using a key generation algorithm, to obtain the fourth key; or performs calculation on the first key and the identifier of the second network by using a key generation algorithm, to obtain the fourth key; or performs calculation on the first key, the identifier of the second network, and the fourth random number by using a key generation algorithm, to obtain the fourth key. Subsequently, the first node sends the fifth message to the blockchain node.

It may be understood that, in S604, the first node may trigger, in a blockchain, generation of a blockchain transaction (referred to as a third transaction below) corresponding to the fourth key. For example, if the first node is a node in the blockchain, the first node triggers the generation of the third transaction; or if the first node is not a node in the blockchain, the first node triggers the blockchain node to generate the third transaction. Subsequently, the second network may obtain the fourth key by using the blockchain. In an embodiment, the second network further obtains an identifier of the third transaction. The foregoing process is similar to the process in which the first node sends the third message to the blockchain node in S303. For details, refer to corresponding descriptions in S303. Details are not described herein again.

In an embodiment, the identifier of the third transaction includes an address of the third transaction, or the identifier of the third transaction includes an address of the third transaction and a sequence number of the terminal in the third transaction. The address of the third transaction is an address of the third transaction in the blockchain.

In an embodiment, after receiving the fifth message, the blockchain node sends a response message of the fifth message to the first node, to indicate, to the first node, that the fifth message is received.

S605: The first node sends second indication information to the terminal. Correspondingly, the terminal receives the second indication information from the first node.

In an embodiment of the application, the second indication information may indicate the terminal to generate the fourth key, or indicate the terminal to generate a new key.

In an embodiment, the first node sends the identifier of the third transaction to the terminal. Correspondingly, the terminal receives the identifier of the third transaction from the first node.

It may be understood that, the identifier of the third transaction and the second indication information may be included in one message and sent to the terminal, or may be separately included in different messages and sent to the terminal. This is not limited.

S606: The terminal generates the fourth key based on the first key.

For example, the terminal performs calculation on the first key by using the key generation algorithm, to obtain the fourth key; or performs calculation on the first key and the identifier of the second network by using the key generation algorithm, to obtain the fourth key; or performs calculation on the first key, the identifier of the second network, and the fourth random number by using the key generation algorithm, to obtain the fourth key.

It may be understood that, after S606, the terminal and the second network may obtain the fourth key and the identifier of the third transaction.

In an embodiment, after S606, the terminal and the second network may perform authentication based on the fourth key and the identifier of the third transaction. For details, refer to the corresponding descriptions in S403.

The actions of the terminal, the first node, or the target network (which may be a node in the target network) in S601 to S606 may be performed by the processor 201 in the communication apparatus 20 shown in FIG. 2 by invoking the application program code stored in the memory 203. This is not limited in embodiments of this application.

Based on the method shown in FIG. 6, the terminal may trigger the first node to configure the key for the terminal and the second network. If the second network is the same as the target network, the terminal may trigger the update of the key for authentication between the terminal and the target network, to improve communication security. If the second network is different from the target network, the terminal may access the second network based on the key configured by the first node without replacing a SIM card. This is very convenient.

The embodiments mentioned above in this application may be combined when the solutions do not conflict. This is not limited.

It may be understood that in the foregoing embodiments, the methods and/or the operations implemented by the terminal may alternatively be implemented by a component (for example, a chip or a circuit) that can be used in the terminal; the methods and/or the operations implemented by the first node may alternatively be implemented by a component (for example, a chip or a circuit) that can be used in the first node; the methods and/or the operations implemented by the node in the target network may alternatively be implemented by a component (for example, a chip or a circuit) that can be used in the node in the target network; the methods and/or the operations implemented by the node in the first network may alternatively be implemented by a component (for example, a chip or a circuit) that can be used in the node in the first network; and the methods and/or the operations implemented by the node in the second network may alternatively be implemented by a component (for example, a chip or a circuit) that can be used in the node in the second network.

The foregoing mainly describes the solutions provided in embodiments of this application from a perspective of interaction between network elements. Correspondingly, an embodiment of this application further provides a communication apparatus. The communication apparatus may be the terminal in the foregoing method embodiments, or an apparatus including the terminal, or a component that can be used in the terminal; or the communication apparatus may be the first node in the foregoing method embodiments, or an apparatus including the first node, or a component that can be used in the first node; or the communication apparatus may be the node in the target network in the foregoing method embodiments, or an apparatus including the node in the target network, or a component that can be used in the node in the target network; or the communication apparatus may be the node in the first network in the foregoing method embodiments, or an apparatus including the node in the first network, or a component that can be used in the node in the first network; or the communication apparatus may be the node in the second network in the foregoing method embodiments, or an apparatus including the node in the second network, or a component that can be used in the node in the second network. It may be understood that, to implement the foregoing functions, the terminal, the first node, the node in the target network, the node in the first network, the node in the second network, or the like includes corresponding hardware structures and/or software modules for performing the functions. One of ordinary skilled in the art should be easily aware that, in combination with units and algorithm operations of the examples described in embodiments disclosed in this specification, this application can be implemented by hardware or a combination of hardware and computer software. Whether a function is performed by hardware or hardware driven by computer software depends on particular applications and design constraints of the technical solutions. One of ordinary skilled in the art may use different methods to implement the described functions for each particular application, but it should not be considered that the implementation goes beyond the scope of this application.

In embodiments of this application, the terminal, the first node, the node in the target network, the node in the first network, the node in the second network, or the like may be divided into function modules based on the foregoing method examples. For example, the function modules corresponding to the functions may be obtained through division, or two or more functions may be integrated into one processing module. The integrated module may be implemented in a form of hardware, or may be implemented in a form of a software functional module. It may be understood that, in embodiments of this application, module division is an example, and is merely a logical function division. In an actual implementation, another division manner may be used.

For example, when the functional modules are obtained through division in an integrated manner, FIG. 7 is a diagram of a structure of a communication apparatus 70. The communication apparatus 70 includes a transceiver module 701. In an embodiment, the communication apparatus 70 further includes a processing module 702. The transceiver module 701 may also be referred to as a transceiver unit, is configured to perform sending and receiving operations, and for example, may be a transceiver circuit, a transceiver machine, a transceiver, or a communication interface. The processing module 702 may also be referred to as a processing unit, is configured to perform an operation other than the sending and receiving operations, and for example, may be a processing circuit or a processor.

In some embodiments, the communication apparatus 70 may further include a storage module (not shown in FIG. 7), configured to store program instructions and data.

For example, the communication apparatus 70 is configured to implement a function of the terminal. The communication apparatus 70 is, for example, the terminal in the embodiment shown in FIG. 3, the embodiment shown in FIG. 4, the embodiment shown in FIG. 5, or the embodiment shown in FIG. 6.

The transceiver module 701 is configured to send a first message to a first node, where the first message indicates that the communication apparatus 70 is to access a network. For example, the transceiver module 701 may be configured to perform S301.

The transceiver module 701 is further configured to receive a second message from the first node, where the second message includes key information, the key information is used for determining a first key, and the first key is used for authentication between the communication apparatus 70 and a target network. For example, the transceiver module 701 is further configured to perform S304.

In an embodiment, the second message further includes an identifier of a first transaction and at least one of the following: an identifier of the target network or a public key of the target network; and the first transaction is a blockchain transaction corresponding to the first key.

In an embodiment, the transceiver module 701 is further configured to send a first request to the target network, where the first request is used for requesting to access the target network, and the first request includes the identifier of the first transaction; and the transceiver module 701 is further configured to receive an authentication message from the target network, where the authentication message corresponds to the first key.

In an embodiment, the transceiver module 701 is further configured to send an identifier of the communication apparatus 70 to the target network.

In an embodiment, the transceiver module 701 is further configured to send a second request to a first network, where the second request is used for requesting to access the first network, and the second request includes the identifier of the first transaction and the identifier of the target network; the transceiver module 701 is further configured to receive first indication information from the first network, where the first indication information indicates the communication apparatus 70 to generate a second key, and the second key is used for authentication between the communication apparatus 70 and the first network; and the processing module 702 is configured to generate the second key based on the first key and an identifier of the first network.

In an embodiment, the transceiver module 701 is further configured to receive an identifier of a second transaction from the first network, where the second transaction is a blockchain transaction corresponding to the second key.

In an embodiment, the transceiver module 701 is further configured to send a third message to the first node, where the third message indicates a third network; the transceiver module 701 is further configured to receive second indication information from the first node, where the second indication information indicates the communication apparatus 70 to generate a third key, and the third key is used for authentication between the communication apparatus 70 and the third network; and the processing module 702 is configured to generate the third key based on the first key and an identifier of the third network.

In an embodiment, the transceiver module 701 is further configured to receive an identifier of a third transaction from the first node, where the third transaction is a blockchain transaction corresponding to the third key.

In an embodiment, the transceiver module 701 is further configured to send a first random number to the first network.

In an embodiment, the identifier of the first transaction includes an address of the first transaction, or the identifier of the first transaction includes an address of the first transaction and a sequence number of the communication apparatus 70 in the first transaction.

In an embodiment, the target network is determined based on selection of a user corresponding to the communication apparatus 70; the target network is determined according to a preset policy; or the target network is determined by the first node.

In an embodiment, the key information includes the first key; or the key information includes the third key, and the third key is used for determining the first key.

In an embodiment, the transceiver module 701 is further configured to send a second random number to the first node.

In an embodiment, that the third key is used for determining the first key includes: The third key is used for determining the first key together with the identifier of the target network and the second random number.

In an embodiment, the first message includes information about the target network.

When the communication apparatus 70 is configured to implement functions of the terminal, for other functions that can be implemented by the communication apparatus 70, refer to related descriptions of the embodiment shown in FIG. 3, the method embodiment shown in FIG. 4, the embodiment shown in FIG. 5, or the embodiment shown in FIG. 6. Details are not described again.

In a simple embodiment, one of ordinary skilled in the art may figure out that the communication apparatus 70 may be in the form shown in FIG. 2. For example, the processor 201 in FIG. 2 may invoke the computer-executable instructions stored in the memory 203, to enable the communication apparatus 70 to perform the method in the foregoing method embodiments.

For example, functions/implementation processes of the transceiver module 701 and the processing module 702 in FIG. 7 may be implemented by the processor 201 in FIG. 2 by invoking the computer-executable instructions stored in the memory 203. Alternatively, functions/implementation processes of the processing module 702 in FIG. 7 may be implemented by the processor 201 in FIG. 2 by invoking the computer-executable instructions stored in the memory 203, and functions/implementation processes of the transceiver module 701 in FIG. 7 may be implemented by the communication interface 204 in FIG. 2.

For example, when the functional modules are obtained through division in an integrated manner, FIG. 8 is a diagram of a structure of a communication apparatus 80. The communication apparatus 80 includes a transceiver module 801 and a processing module 802. The transceiver module 801 may also be referred to as a transceiver unit, is configured to perform sending and receiving operations, and for example, may be a transceiver circuit, a transceiver machine, a transceiver, or a communication interface. The processing module 802 may also be referred to as a processing unit, is configured to perform an operation other than the sending and receiving operations, and for example, may be a processing circuit or a processor.

In some embodiments, the communication apparatus 80 may further include a storage module (not shown in FIG. 8), configured to store program instructions and data.

For example, the communication apparatus 80 is configured to implement a function of the first node. For example, the communication apparatus 80 may be the first node in the embodiment shown in FIG. 3 or the embodiment shown in FIG. 6.

The transceiver module 801 is configured to receive a first message from a terminal, where the first message indicates that the terminal is to access a network. For example, the transceiver module 801 may be configured to perform S301.

The processing module 802 is configured to obtain a first key, where the first key is used for authentication between the terminal and a target network. For example, the processing module 802 may be configured to perform S302.

The transceiver module 801 is further configured to send a third message to a blockchain node, where the third message indicates the first key to the target network. For example, the transceiver module 801 may be further configured to perform S303.

The transceiver module 801 is further configured to send a second message to the terminal, where the second message includes key information, and the key information is determined based on the first key. For example, the transceiver module 801 may be further configured to perform S304.

In an embodiment, the processing module 802 is further configured to obtain an identifier of a first transaction, where the first transaction is a blockchain transaction corresponding to the first key.

In an embodiment, the second message further includes the identifier of the first transaction and at least one of the following: an identifier of the target network or a public key of the target network.

In an embodiment, the identifier of the first transaction includes an address of the first transaction, or the identifier of the first transaction includes an address of the first transaction and a sequence number of the terminal in the first transaction.

In an embodiment, the transceiver module 801 is further configured to receive a fourth message from the terminal, where the fourth message indicates a second network; the transceiver module 801 is further configured to send a fifth message to the blockchain node, where the fifth message includes a fourth key, and the fourth key is used for authentication between the terminal and the second network; and the transceiver module 801 is further configured to send second indication information to the terminal, where the second indication information indicates the terminal to generate the fourth key.

In an embodiment, the processing module 802 is further configured to obtain an address of a third transaction, where the third transaction is a blockchain transaction corresponding to the fourth key.

In an embodiment, the transceiver module 801 is further configured to send an identifier of the third transaction to the terminal.

In an embodiment, the key information includes the first key; or the key information includes the third key, and the third key is used for determining the first key.

In an embodiment, the transceiver module 801 is further configured to receive a second random number from the terminal.

In an embodiment, that the third key is used for determining the first key includes: The third key is used for determining the first key together with the identifier of the target network and the second random number.

In an embodiment, the blockchain node is included in the target network, and the third message is obtained by encrypting the first key by using the public key of the target network.

In an embodiment, the first message includes information about the target network.

When the communication apparatus 80 is configured to implement functions of the first node, for other functions that can be implemented by the communication apparatus 80, refer to the related descriptions in the embodiment shown in FIG. 3 or the embodiment shown in FIG. 6. Details are not described again herein.

Alternatively, for example, the communication apparatus 80 is configured to implement a function of the node in the target network. For example, the communication apparatus 80 is the node in the target network in the embodiment shown in FIG. 4, the embodiment shown in FIG. 5, or the embodiment shown in FIG. 6.

The processing module 802 is configured to obtain a third message.

The processing module 802 is further configured to obtain a first key based on the third message, where the first key is used for authentication between a first terminal and the target network.

The processing module 802 is further configured to obtain an identifier of a first transaction, where the first transaction is a blockchain transaction corresponding to the first key.

The processing module 802 is further configured to verify the first terminal based on the first key and the identifier of the first transaction.

The transceiver module 801 is further configured to send a verification response message to the first terminal based on a verification result.

In an embodiment, the processing module 802 is configured to receive a first request from the first terminal through the transceiver module 801, where the first request is used for requesting to access the target network, and the first request includes the identifier of the first transaction; and the processing module 802 is further configured to send an authentication message to the first terminal through the transceiver module 801, where the authentication message is obtained based on the first key, and the first key is obtained through query based on the first request.

In an embodiment, the transceiver module 801 is further configured to send a query message to a blockchain node, where the query message is used for querying for a key corresponding to the first transaction, and the query message includes the identifier of the first transaction; and the transceiver module 801 is further configured to receive a response message from the blockchain node, where the response message includes the first key.

In an embodiment, the transceiver module 801 is further configured to receive an identifier of the first terminal from the first terminal.

In an embodiment, the transceiver module 801 is further configured to receive a third request from a second terminal, where the third request is used for requesting to access the target network, the third request includes an identifier of a fourth transaction and an identifier of a third network, the fourth transaction is a blockchain transaction corresponding to a fifth key, and the fifth key is used for authentication between the second terminal and the third network; the transceiver module 801 is further configured to send the identifier of the fourth transaction to the third network; the processing module 802 is further configured to obtain a sixth key, where the sixth key is used for authentication between the second terminal and the target network; and the transceiver module 801 is further configured to send third indication information to the second terminal, where the third indication information indicates the second terminal to generate the sixth key.

In an embodiment, the processing module 802 is further configured to obtain an identifier of a fifth transaction, where the fifth transaction is a blockchain transaction corresponding to the sixth key; and the transceiver module 801 is further configured to send the identifier of the fifth transaction to the second terminal.

In an embodiment, the transceiver module 801 is further configured to receive the identifier of the first transaction from a second network; and the transceiver module 801 is further configured to send a second key to the blockchain node, where the second key is used for authentication between the first terminal and the second network, the second key is obtained based on the first key, and the first key is obtained through query based on the identifier of the first transaction.

In an embodiment, the identifier of the first transaction includes an address of the first transaction, or the identifier of the first transaction includes an address of the first transaction and a sequence number of the first terminal in the first transaction.

When the communication apparatus 80 is configured to implement functions of the node in the target network, for other functions that can be implemented by the communication apparatus 80, refer to the related descriptions in the embodiment shown in FIG. 3 or the embodiment shown in FIG. 6. Details are not described again herein.

Alternatively, for example, the communication apparatus 80 is configured to implement a function of the terminal. For example, the communication apparatus 80 is the terminal described in the embodiment shown in FIG. 4.

The processing module 802 is configured to obtain an identifier of a first transaction and a first key, where the first transaction is a blockchain transaction corresponding to the first key. For example, the processing module 802 may be configured to perform S401.

The processing module 802 is further configured to perform authentication with a target network based on the identifier of the first transaction and the first key. For example, the processing module 802 may be further configured to perform S403.

The transceiver module 801 is configured to receive a verification response message from the target network.

In an embodiment, the processing module 802 is configured to send a first request to the target network through the transceiver module 801, where the first request is used for requesting to access the target network, and the first request includes the identifier of the first transaction; the processing module 802 is further configured to receive an authentication message from the target network through the transceiver module 801, where the authentication message is obtained based on the first key, and the first key is obtained through query based on the first request; and the processing module 802 is further configured to verify the authentication message.

In an embodiment, the transceiver module 801 is further configured to send an identifier of the communication apparatus 80 to the target network.

In an embodiment, the first request is obtained by encrypting the identifier of the first transaction by using a public key of the target network.

When the communication apparatus 80 is configured to implement the function of the terminal, for other functions that can be implemented by the communication apparatus 80, refer to related descriptions of the embodiment shown in FIG. 4. Details are not described again.

In a simple embodiment, one of ordinary skilled in the art may figure out that the communication apparatus 80 may be in the form shown in FIG. 2. For example, the processor 201 in FIG. 2 may invoke the computer-executable instructions stored in the memory 203, to enable the communication apparatus 80 to perform the method in the foregoing method embodiments.

For example, functions/implementation processes of the transceiver module 801 and the processing module 802 in FIG. 8 may be implemented by the processor 201 in FIG. 2 by invoking the computer-executable instructions stored in the memory 203. Alternatively, functions/implementation processes of the processing module 802 in FIG. 8 may be implemented by the processor 201 in FIG. 2 by invoking the computer-executable instructions stored in the memory 203, and functions/implementation processes of the transceiver module 801 in FIG. 8 may be implemented by the communication interface 204 in FIG. 2.

It may be understood that, one or more of the foregoing modules or units may be implemented by using software, hardware, or a combination thereof. When any one of the foregoing modules or units is implemented by software, the software exists in a form of computer program instructions, and is stored in the memory. The processor may be configured to execute the program instructions and implement the foregoing method procedure. The processor may be built into a system on chip (SoC) or an ASIC, or may be an independent semiconductor chip. In addition to a core configured to perform calculation or processing by executing a software instruction, the processor may further include a necessary hardware accelerator, for example, a field programmable gate array (FPGA), a programmable logic device (PLD), or a logic circuit that implements a dedicated logic operation.

When the foregoing modules or units are implemented by using hardware, the hardware may be any one or any combination of a CPU, a microprocessor, a digital signal processing (DSP) chip, a microcontroller unit (MCU), an artificial intelligence processor, an ASIC, a SoC, an FPGA, a PLD, a dedicated digital circuit, a hardware accelerator, or a non-integrated discrete device, and the hardware may run necessary software or does not depend on software to perform the foregoing method procedures.

For example, an embodiment of the application further provides a chip system, including: at least one processor and an interface, where the at least one processor is coupled to a memory by using an interface, and when the at least one processor executes a computer program or instructions in the memory, the method in any one of the foregoing method embodiments is performed. In an embodiment, the chip system further includes the memory. In an embodiment, the chip system may include a chip, or may include a chip and another discrete component. This is not specifically limited in an embodiment of the application.

For example, an embodiment of the application further provides a computer-readable storage medium. All or some of the procedures in the foregoing method embodiments may be implemented by a computer program instructing related hardware. The program may be stored in the computer-readable storage medium. When the program is executed, the procedures of the foregoing method embodiments may be included. The computer-readable storage medium may be an internal storage unit of the communication apparatus in any one of the foregoing embodiments, for example, a hard disk or memory of the communication apparatus. Alternatively, the computer-readable storage medium may be an external storage device of the communication apparatus, for example, a plug-in hard disk, a smart media card (SMC), a secure digital (SD) card, or a flash card that is configured on the communication apparatus. Further, the computer-readable storage medium may include both an internal storage unit and an external storage device of the communication apparatus. The computer-readable storage medium is configured to store the computer program and store other programs and data that are required by the communication apparatus. The computer-readable storage medium may be further configured to temporarily store data that has been output or is to be output.

For example, an embodiment of the application further provides a computer program product. All or some of the procedures in the foregoing method embodiments may be implemented by a computer program instructing related hardware. The program may be stored in the computer program product. When the program is executed, the procedures of the foregoing method embodiments may be included.

For example, an embodiment of the application further provides computer instructions. All or some of the procedures in the foregoing method embodiments may be implemented by computer instructions instructing related hardware (such as a computer, a processor, an access network device, a mobility management network element, or a session management network element). The program may be stored in the computer-readable storage medium or the computer program product.

For example, an embodiment of the application further provides a communication system, including the terminal and the first node in the foregoing embodiments.

For example, an embodiment of the application further provides a communication system, including the terminal and the node in the target network in the foregoing embodiments.

For example, an embodiment of the application further provides a communication system, including the terminal, the first node, and the node in the target network in the foregoing embodiments.

The foregoing descriptions about implementations allow one of ordinary skilled in the art to understand that, for the purpose of convenient and brief description, division of the foregoing functional modules is taken as an example for illustration. In actual application, the foregoing functions can be allocated to different modules and implemented according to a requirement, that is, an inner structure of an apparatus is divided into different functional modules to implement all or some of the functions described above.

In the several embodiments provided in this application, it should be understood that the disclosed apparatus and method may be implemented in other manners. For example, the described apparatus embodiment is merely an example. For example, the module or division into the units is merely logical function division and may be other division in actual implementation. For example, a plurality of units or components may be combined or integrated into another apparatus, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may be one or more physical units, may be located in one place, or may be distributed on different places. Some or all of the units may be selected based on actual requirements to achieve the objectives of the solutions of embodiments.

In addition, functional units in embodiments of this application may be integrated into one processing unit, each of the units may exist alone physically, or two or more units are integrated into one unit. The integrated unit may be implemented in a form of hardware, or may be implemented in a form of a software functional unit.

The foregoing descriptions are merely implementations of this application, but are not intended to limit the protection scope of this application. Any variation or replacement within the technical scope disclosed in this application shall fall within the protection scope of this application. Therefore, the protection scope of this application shall be subject to the protection scope of the claims.

What is claimed is:

1. A key obtaining method applied to a terminal, comprising:
sending a first message indicating that the terminal is to access a network; and
receiving a second message having key information for determining a first key for authentication between the terminal and a target network.

2. The method according to claim 1, wherein the second message further comprises an identifier of a first transaction and one or more of: an identifier of the target network or a public key of the target network; and
the first transaction is a blockchain transaction corresponding to the first key.

3. The method according to claim 2, further comprising:
sending a first request to the target network, wherein the first request is used for requesting to access the target network, and the first request comprises the identifier of the first transaction; and
receiving an authentication message from the target network, wherein the authentication message corresponds to the first key.

4. The method according to claim 3, further comprising:
sending an identifier of the terminal to the target network.

5. The method according to claim 2, further comprising:
sending a second request for requesting to access a first network, wherein the second request comprises the identifier of the first transaction and the identifier of the target network;
receiving first indication information indicating the terminal to generate a second key for authentication between the terminal and the first network; and
generating the second key based on the first key and an identifier of the first network.

6. The method according to claim 5, further comprising:
receiving an identifier of a second transaction that is a blockchain transaction corresponding to the second key.

7. The method according to claim 5, further comprising:
sending a first random number to the first network.

8. The method according to claim 2, wherein the identifier of the first transaction comprises an address of the first transaction.

9. The method according to claim 8, wherein the identifier of the first transaction further comprises a sequence number of the terminal in the first transaction.

10. The method according to claim 1, wherein the target network is determined based on one of:
selection of a user corresponding to the terminal;
a preset policy; or
determination of a first node.

11. A key obtaining method, comprising:
receiving a first message from a terminal, wherein the first message indicates that the terminal is to access a network;
obtaining a first key for authentication between the terminal and a target network;
sending a third message to a blockchain node, wherein the third message indicates the first key to the target network; and
sending a second message to the terminal, wherein the second message comprises key information determined based on the first key.

12. The method according to claim 11, wherein before the sending the second message to the terminal, the method further comprises:
obtaining an identifier of a first transaction that is a blockchain transaction corresponding to the first key.

13. The method according to claim 12, wherein the second message further comprises the identifier of the first transaction and one or more of: an identifier of the target network or a public key of the target network.

14. The method according to claim 13, wherein the identifier of the first transaction comprises an address of the first transaction.

15. The method according to claim 14, wherein the identifier of the first transaction further comprises a sequence number of the terminal in the first transaction.

16. The method according to claim 11, further comprising:
receiving a fourth message from the terminal, wherein the fourth message indicates a second network;
sending a fifth message to the blockchain node, wherein the fifth message comprises a fourth key for authentication between the terminal and the second network; and
sending second indication information to the terminal, wherein the second indication information indicates the terminal to generate the fourth key.

17. A key obtaining method applied to a node in a target network, comprising:
obtaining a third message;
obtaining a first key based on the third message, wherein the first key is used for authentication between a first terminal and the target network;
obtaining an identifier of a first transaction that is a blockchain transaction corresponding to the first key;
verifying the first terminal based on the first key and the identifier of the first transaction; and
sending a verification response message to the first terminal based on a verification result.

18. The method according to claim 17, wherein the verifying the first terminal based on the first key and the identifier of the first transaction comprises:
receiving a first request from the first terminal, wherein the first request is used for requesting to access the target network, and the first request comprises the identifier of the first transaction; and
sending an authentication message to the first terminal, wherein the authentication message is obtained based on the first key obtained through query based on the first request.

19. The method according to claim 18, wherein before the sending the authentication message to the first terminal, the method further comprises:
sending a query message to a blockchain node, wherein the query message is used for querying for a key corresponding to the first transaction, and the query message comprises the identifier of the first transaction; and
receiving a response message from the blockchain node, wherein the response message comprises the first key.

20. The method according to claim 18, further comprising:
receiving an identifier of the first terminal from the first terminal.
